(19) United States
(12) Patent Application Publication
(10) Pub. No.: US 2024/0129735 A1
(43) Pub. Date: Apr. 18, 2024

(54) MOBILITY SERVICE PROVIDING SYSTEM, MOBILITY SERVICE PROVIDING SERVER, VEHICLE DATA PROVIDING METHOD, AND STORAGE MEDIUM

(71) Applicant: DENSO CORPORATION, Kariya-city (JP)

(72) Inventors: Masatoshi KOMIYAMA, Kariya-city (JP); Kensho TAKI, Kariya-city (JP); Lingfei XIE, Kariya-city (JP); shigeru KAJIOKA, Kariya-city (JP); Makiko TAUCHI, Kariya-city (JP)

(21) Appl. No.: 18/397,605

(22) Filed: Dec. 27, 2023

Related U.S. Application Data
(63) Continuation of application No. PCT/JP2022/025812, filed on Jun. 28, 2022.

(30) Foreign Application Priority Data
Jul. 2, 2021 (JP) 2021-110905

(51) Int. Cl. H04W 12/08; H04W 12/06

(52) U.S. Cl. CPC H04W 12/08; H04W 12/06; G07C 5/008

(57) ABSTRACT

When an interface unit has received a first access request, first control units acquire vehicle data from storage units, and provide the vehicle data to a request source through an interface unit. When the interface unit has received a second access request, a second control unit acquires the access result including the vehicle data from a vehicle-mounted machine by accessing the vehicle-mounted machine, and provides the access result to the request source through the interface unit.

### CROSS REFERENCE TO RELATED APPLICATIONS

The present application is a continuation application of International Patent Application No. PCT/JP2022/025812 filed on Jun. 28, 2022 which designated the U.S. and claims the benefit of priority from Japanese Patent Application No. 2021-110905 filed on Jul. 2, 2021. The entire disclosures of all of the above application are incorporated herein by reference.

### TECHNICAL FIELD

The present disclosure relates to a technology for providing a mobility service.

### BACKGROUND

A related art describes a digital twin simulation that reproduces a state of a vehicle in a real world in a virtual space by collecting vehicle data from the vehicle.

### SUMMARY

According to one example of the present disclosure, a mobility service providing system including an onboard device configured to collect vehicle data and a mobility service providing server configured to wirelessly communicate with the onboard device is provided. The onboard device is configured to repeatedly spontaneously transmit the vehicle data to the mobility service providing server and to transmit the vehicle data to the mobility service providing server in response to a request from the mobility service providing server. The mobility service providing server is configured to store the vehicle data, accept access request from outside, provide the vehicle data to a request source.

### BRIEF DESCRIPTION OF THE DRAWINGS

FIG. 1 is a block diagram illustrating a configuration of a mobility IoT system.

FIG. 2 is a block diagram illustrating a configuration of an edge device.

FIG. 3 is a functional block diagram illustrating a functional configuration of an edge device.

FIG. 4 is a diagram illustrating a configuration of a frame.

FIG. 5 is a diagram illustrating a configuration of a vehicle data conversion table.

FIG. 6 is a diagram illustrating a first hierarchy of standardized vehicle data and a data format.

FIG. 7 is a diagram illustrating a configuration of standardized vehicle data.

FIG. 8 is a sequence diagram showing a procedure for creating standardized vehicle data.

FIG. 9 is a timing chart illustrating data transmission timing.

FIG. 10 is a block diagram illustrating a configuration of a management center.

FIG. 11 is a functional block diagram illustrating a functional configuration of a management center.

FIG. 12 is a functional block diagram illustrating functional configurations of a mobility GW and a data management unit.

FIG. 13 is a diagram illustrating a configuration of a shadow.

FIG. 14 is a diagram illustrating a configuration of a latest index.

FIG. 15 is a diagram illustrating a configuration of an index.

FIG. 16 is a diagram illustrating a configuration of an authorization object database included in an authorization information memory unit.

FIG. 17 is a diagram illustrating a configuration of an authorization class database included in an authorization information memory unit.

FIG. 18 is a sequence diagram illustrating an operation of an API providing unit.

FIG. 19 is a diagram illustrating a configuration of designation information about a first data acquisition request and a shadow access request.

FIG. 20 is an explanatory diagram of a method of designating an area.

FIG. 21 is a flowchart of a shadow list generation process executed by an index acquisition unit.

FIG. 22 is a sequence diagram illustrating a procedure of data acquisition using a first data acquisition API which is an open API.

FIG. 23 is a diagram illustrating a configuration of designation information about a second data acquisition request.

FIG. 24 is a flowchart of a vehicle data acquisition process executed by a vehicle control unit.

FIG. 25 is a sequence diagram illustrating a procedure of data acquisition using a second data acquisition API which is a close API.

FIG. 26 is a block diagram illustrating a connection state of an ECU mounted on a vehicle.

FIG. 27 is a diagram illustrating a configuration of a server-side authorization database included in a management center in a second embodiment.

FIG. 28 is a block diagram illustrating a functional configuration of an edge device according to the second embodiment.

FIG. 29 is a diagram illustrating a configuration of a vehicle-side authorization database included in an edge device in the second embodiment.

FIG. 30 is a sequence diagram illustrating a procedure of two-stage authorization for executing an authorization process in both the management center and the edge device.

FIG. 31 is a sequence diagram illustrating a procedure of vehicle-side single authorization for executing an authorization process only on an edge device side.

### DETAILED DESCRIPTION

In response to the spread of mobility services, for example, there is provided a fleet service in which a service administrator centrally manages vehicles to be managed by periodically collecting vehicle data such as GPS information from the vehicles to be managed and displaying the positions of the vehicles to be managed on a map screen of a browser.

When vehicle data is acquired, there are two ways: a method of directly acquiring data from a real vehicle and a method of completing in a cloud by acquiring data from a shadow on the cloud using a virtual environment such as a digital twin.

In the case of directly acquiring data from an actual vehicle, it is possible to handle low data of the vehicle, but depending on a vehicle state such as power off, it is difficult to handle the data because the data cannot be acquired or the data is not normalized to a form that is easy to handle.

When it is completed in the cloud, it is not affected by the vehicle state, but only normalized vehicle data can be handled.

The present disclosure provides a technology for realizing data provision according to use in a mobility service providing system.

According to one aspect of the present disclosure, a mobility service providing system comprises an in-vehicle device and a mobility service providing server. The in-vehicle device is mounted on a vehicle and is configured to collect vehicle data that is data acquired from the vehicle. The mobility service providing server is configured to perform wireless communication with the in-vehicle device. The in-vehicle device is configured to repeatedly and spontaneously transmit the vehicle data to the mobility service providing server, and transmits the vehicle data to the mobility service providing server in response to a request from the mobility service providing server.

The mobility service providing server includes a memory unit configured to store the vehicle data for each predetermined time point acquired from the in-vehicle device by the wireless communication, an interface unit configured to accept a first access request and a second access request from an outside, a first control unit configured to acquire the vehicle data from the memory unit and provide the vehicle data to a request source via the interface unit when the interface unit receives the first access request, and a second control unit configured to acquire an access result including the vehicle data from the in-vehicle device by accessing the in-vehicle device and provide the access result to a request source via the interface unit when the interface unit receives the second access request.

According to such a configuration, by using the interface unit of the mobility service providing server, both the vehicle data acquired from the vehicle on which the in-vehicle device is mounted and stored in the memory unit of the mobility service providing server and the vehicle data of the vehicle on which the in-vehicle device is mounted can be acquired.

According to one aspect of the present disclosure, a mobility service providing server comprises a memory unit, an interface unit, a first control unit, and a second control unit. The memory unit is configured to store vehicle data provided from an in-vehicle device mounted on a vehicle. The interface unit is configured to receive a first access request and a second access request from an outside. The first control unit is configured to acquire the vehicle data from the memory unit and provide the vehicle data to a request source via the interface unit when the interface unit receives the first access request. The second control unit is configured to acquire an access result including the vehicle data from the in-vehicle device by accessing the in-vehicle device and provide the access result to a request source via the interface unit when the interface unit receives the second access request.

According to such a configuration, a mobility service providing system having the above effect can be constructed.

According to one aspect of the present disclosure, a vehicle data providing method is provided. A mobility serviced providing server to which the vehicle data providing method is applied includes a memory unit, and an interface unit.

In the vehicle data providing method, when the interface unit receives a first access request, the vehicle data is acquired from the memory unit, and the vehicle data is provided to a request source via the interface unit. when the interface unit receives the second access request, an access result including the vehicle data is acquired from the in-vehicle device by accessing the in-vehicle device and the access result is provided to a request source via the interface unit.

According to one aspect of the present disclosure, a program and a storage medium are provided. A computer executing a program configures a mobility service providing server together with a memory unit and an interface unit.

The program causes a computer to function as a first control unit and a second control unit. The first control unit acquires the vehicle data from the memory unit and provides the vehicle data to a request source via the interface unit when the interface unit receives the first access request. The second control unit acquires an access result including the vehicle data from the in-vehicle device by accessing the in-vehicle device and provides the access result to a request source via the interface unit when the interface unit receives the second access request.

Hereinafter, embodiments of the present disclosure will be described with reference to the drawings.

### 1. First Embodiment

[1-1. System Overview]

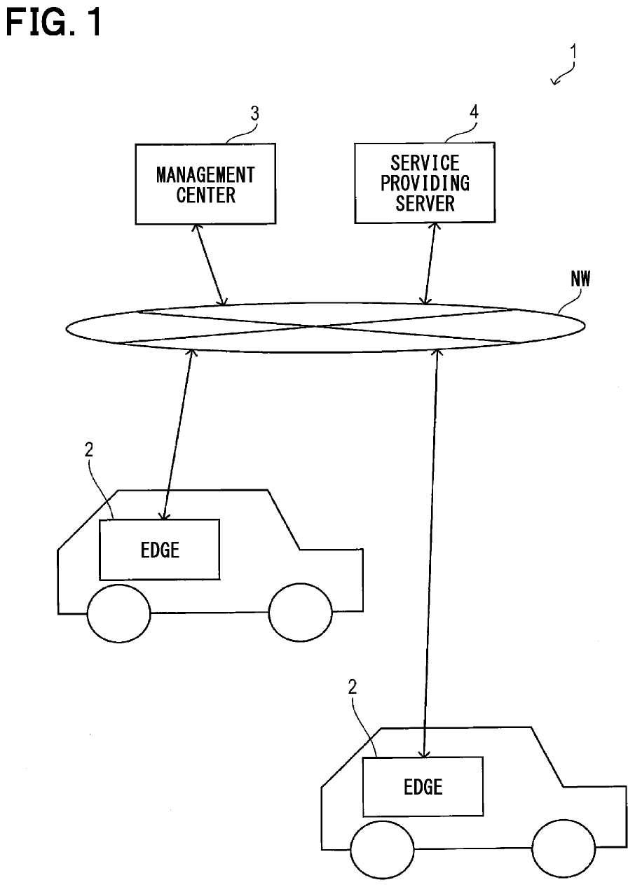

As illustrated in FIG. 1, a mobility IoT system 1 of the present embodiment includes a plurality of edge devices 2, a management center 3, and a service providing server 4. IoT stands for Internet of Things.

The edge device 2 is mounted on a vehicle and has a function of performing data communication with the management center 3 via a wide area wireless communication network NW.

The management center 3 is a device that manages the mobility IoT system 1. The management center 3 has a function of performing data communication with the plurality of edge devices 2 and the service providing server 4 via the wide area wireless communication network NW.

The service providing server 4 is, for example, a server installed to provide a service for managing the operation of the vehicle. Note that the mobility IoT system 1 may include a plurality of service providing servers 4 having different service content. The service providing server 4 may be configured as an on-premises server or may be configured as a cloud server. In addition, the service providing server 4 may be configured as a server that is physically the same as the management center 3.

[1-2. Edge Device]

[1-2-1. Device Configuration]

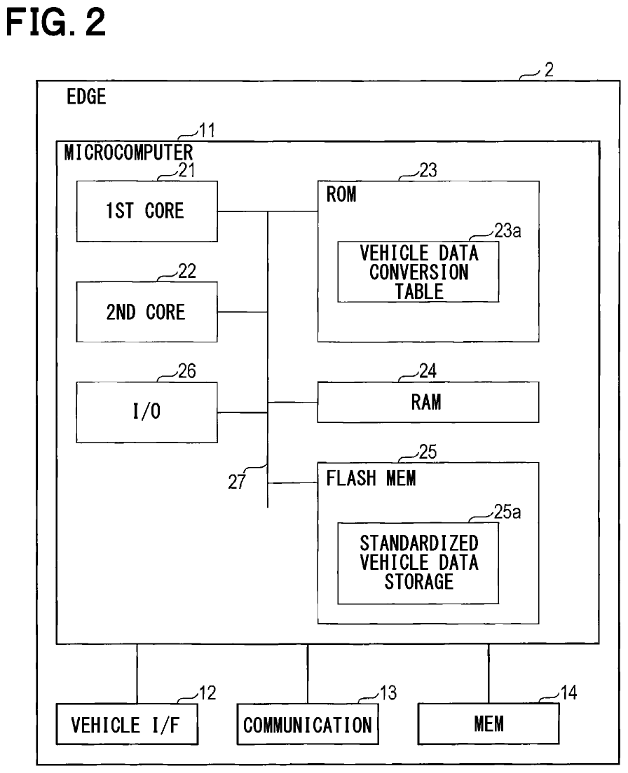

As illustrated in FIG. 2, the edge device 2 includes a microcomputer 11, a vehicle interface (vehicle I/F) 12, a communication unit 13, and a memory unit 14.

The microcomputer 11 includes a first core 21, a second core 22, a ROM 23, a RAM 24, a flash memory 25, an input/output unit 26, and a bus 27.

Various functions of the microcomputer 11 are implemented by the first core 21 and the second core 22 executing programs stored in a non-transitory tangible recording medium is realized. In this example, the ROM 23 corresponds to a non-transitory tangible recording medium storing a program. Further, by executing this program, a method corresponding to the program is executed.

Some or all of the functions executed by the first core 21 and the second core 22 may be configured as hardware by one or a plurality of ICs or the like.

The flash memory 25 is a data-rewritable nonvolatile memory. The flash memory 25 includes a standardized vehicle data storage unit 25a storing standardized vehicle data to be described later.

The input/output unit 26 is a circuit for inputting/outputting data between the outside of the microcomputer 11 and the first core 21 and the second core 22.

The bus 27 connects the first core 21, the second core 22, the ROM 23, the RAM 24, the flash memory 25, and the input/output unit 26 such that data can be input and output to and from each other.

The vehicle I/F 12 is an input/output circuit for inputting/outputting signals to/from an electronic control device, a sensor, and the like mounted on the vehicle.

The vehicle I/F 12 includes a power supply voltage input port, a general-purpose input/output port, a CAN communication port, an Ethernet communication port, and the like. The CAN communication port is a port for transmitting and receiving data in accordance with the CAN communication protocol. The Ethernet communication port is a port for transmitting and receiving data based on the Ethernet communication protocol. CAN stands for Controller Area Network. CAN is a registered trademark. Ethernet is a registered trademark.

Another electronic control device mounted on the vehicle is connected to the CAN communication port and the Ethernet communication port. The edge device 2 can transmit and receive a communication frame to and from another electronic control device.

The communication unit 13 performs data communication with the management center 3 via the wide area wireless communication network NW.

The memory unit 14 is a storage device for storing various pieces of data.

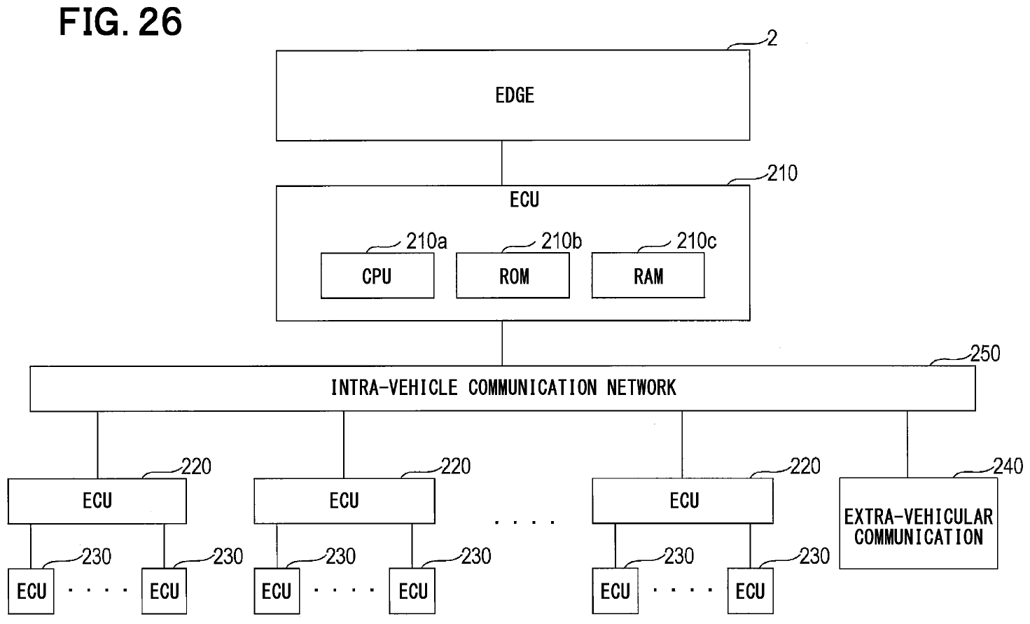

As illustrated in FIG. 26, one ECU 210, a plurality of ECUs 220, a plurality of ECUs 230, an extra-vehicular communication device 240, and an intra-vehicle communication network 250 are mounted on the vehicle. ECU stands for Electronic Control Unit.

The ECU 210 integrates the plurality of ECUs 220 to implement cooperative control of the entire vehicle.

The ECU 220 is provided for each domain divided according to functions in the vehicle, and mainly executes control of the plurality of ECUs 230 existing in the domain. Each ECU 220 is connected to a subordinate ECU 230 via a lower layer network (for example, CAN) individually provided. The ECU 220 has a function of centrally managing access authority and the like to the subordinate ECUs 230 and performing authentication and the like of a user. The domain is, for example, a powertrain, a body, a chassis, a cockpit, or the like.

The ECU 230 connected to the ECU 220 belonging to the domain of the powertrain includes, for example, an ECU 230 that controls an engine, an ECU 230 that controls a motor, an ECU 230 that controls a battery, and the like.

The ECU 230 connected to the ECU 220 belonging to the body domain includes, for example, an ECU 230 that controls an air conditioner, an ECU 230 that controls a door, and the like.

The ECU 230 connected to the ECU 220 belonging to the chassis domain includes, for example, an ECU 230 that controls a brake, an ECU 230 that controls a steering, and the like.

The ECU 230 connected to the ECU 220 belonging to the cockpit domain includes, for example, an ECU 230 that controls meter and navigation display, an ECU 230 that controls an input device operated by an occupant of the vehicle, and the like.

The extra-vehicular communication device 240 performs data communication with a communication device outside the vehicle (for example, a cloud server) via the wide area wireless communication network NW.

The intra-vehicle communication network 250 includes CAN FD and Ethernet. CAN FD stands for CAN with Flexible Data Rate. The CAN FD connects the ECU 210, each ECU 220, and the extra-vehicular communication device 240 via a bus. The Ethernet individually connects the ECU 210, each ECU 220, and the extra-vehicular communication device 240.

The ECU 210 is an electronic control device mainly composed of a microcomputer including a CPU 210a, a ROM 210b, a RAM 210c, and the like. Various functions of the microcomputer are implemented by the CPU 210a executing a program stored in a non-transitory tangible recording medium. In this example, The ROM 210b corresponds to a non-transitory tangible recording medium storing a program. Further, by executing this program, a method corresponding to the program is executed. Some or all of the functions executed by the CPU 210a may be configured as hardware by one or a plurality of ICs or the like. In addition, the number of microcomputers constituting the ECU 210 may be one or more.

Each of the ECU 220, the ECU 230, and the extra-vehicular communication device 240 is an electronic control device mainly including a microcomputer including a CPU, a ROM, a RAM, and the like, as in the ECU 210. In addition, the number of microcomputers constituting the ECU 220, the ECU 230, and the extra-vehicular communication device 240 may be one or more. The ECU 220 is an ECU that controls one or more ECUs 230, and the ECU 210 is an ECU that controls one or more ECUs 220 or controls the ECUs 220, 230 of the entire vehicle including the extra-vehicular communication device 240.

The edge device 2 is connected to the ECU 210 so as to enable data communication with the ECU 210. That is, the edge device 2 receives information about the ECUs 210, 220, 230 via the ECU 210. In addition, the edge device 2 transmits a request related to vehicle control to the ECU 210 or to the ECUs 220, 230 via the ECU 210.

[1-2-2. Functional Configuration]

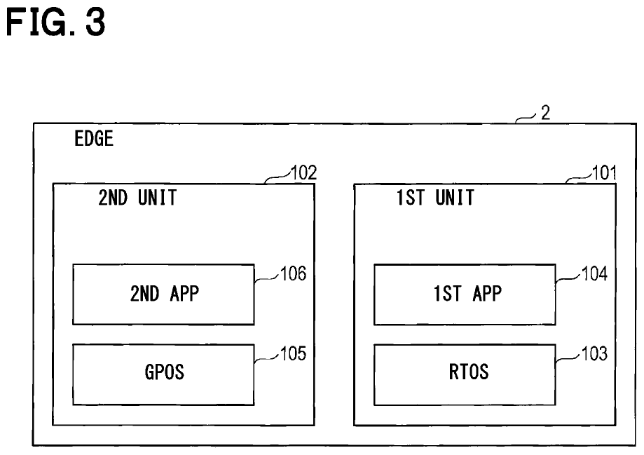

As illustrated in FIG. 3, the edge device 2 includes a first unit 101 as a functional block implemented by the first core 21 executing a program stored in the ROM 23. The edge device 2 includes a second unit 102 as a functional block implemented by the second core 22 executing the program stored in the ROM 23.

The first unit 101 includes a real-time operating system (in the following, RTOS) 103 and a first application 104.

The first application 104 executes various processes for controlling the vehicle. The first application 104 is configured to be able to access the standardized vehicle data storage unit 25a of the flash memory 25 and refer to the standardized vehicle data in order to execute various processes for controlling the vehicle.

The RTOS 103 manages the first application 104 so that real-time performance of processing by the first application 104 can be secured.

The second unit 102 includes a general-purpose operating system (in the following, GPOS) 105 and a second application 106.

The second application 106 executes processing related to a service provided by the service providing server 4. The second application 106 is configured to be able to access the standardized vehicle data storage unit 25a of the flash memory 25 and refer to the standardized vehicle data in order to execute processing related to the service.

The GPOS 105 is basic software installed in the edge device 2 to operate various applications, and manages the second application 106.

[1-2-3. Data Collection Process]

A series of processes in which the edge device 2 collects vehicle data and voluntarily transmits the vehicle data to the management center 3 will be described.

First, processing executed by the vehicle I/F 12 will be described.

Upon receiving the communication frame, the vehicle I/F 12 determines the communication protocol of the communication frame based on the communication port that has received the communication frame. Specifically, for example, when the communication frame is received through the CAN communication port, the vehicle I/F 12 determines that the communication protocol of the received communication frame is the CAN communication protocol. For example, when the communication frame is received through the Ethernet communication port, the vehicle I/F 12 determines that the communication protocol of the received communication frame is the Ethernet communication protocol.

Then, the vehicle I/F 12 determines whether the communication frame is a communication frame to be processed by the edge device 2 based on the identification information about the communication frame to output the received communication frame to the first unit 101 when determining that the communication frame is the communication frame to be processed.

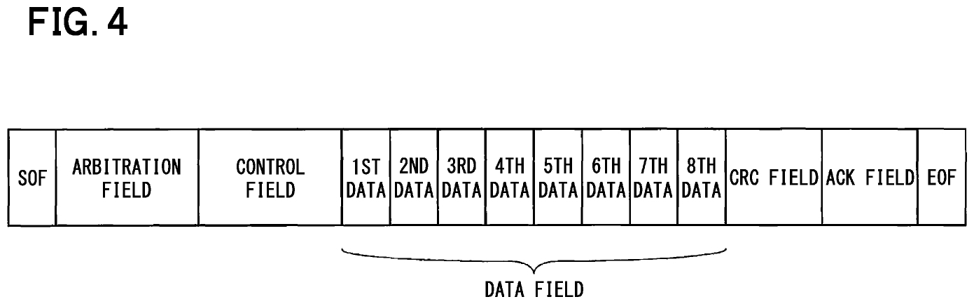

As illustrated in FIG. 4, the CAN frame includes a start of frame, an arbitration field, a control field, a data field, a CRC field, an ACK field, and an end of frame. The arbitration field includes an 11-bit or 29-bit identifier (that is, ID) and 1-bit RTR bit.

Further, an 11-bit identifier used in CAN communication is referred to as a CANID. The CANID is preset based on content of data included in the CAN frame, a transmission source of the CAN frame, a transmission destination of the CAN frame, and the like.

The data field includes first data, second data, third data, fourth data, fifth data, sixth data, seventh data, and eighth data of 8 bits (that is, one byte), respectively. Hereinafter, each of the first to eighth data in the data field is also referred to as CAN data.

Therefore, when receiving the CAN frame, the vehicle I/F 12 determines whether the frame is a frame to be processed based on the CANID.

Next, processing executed by the first unit 101 will be described.

When acquiring the communication frame output from the vehicle I/F 12, the first unit 101 extracts identification information and data from the communication frame, and creates standard format data including the identification information and the data. The first unit 101 stores the created standard format data in the flash memory 25. For example, when acquiring a CAN frame, the first unit 101 creates standard format data including the CANID and the first to eighth data.

When the standard format data including the same identification information as the created standard format data is already stored in the flash memory 25, the first unit 101 updates the standard format data by overwriting the standard format data.

Next, processing executed by the second unit 102 will be described.

The second core 22 acquires the standard format data from the flash memory 25.

Then, the second core 22 divides the data included in the acquired standard format data. For example, since the standard format data generated from the CAN frame includes the CANID and the first to eighth data, the second core 22 divides the first to eighth data by 1 byte and extracts 8 pieces of CAN data. The standard format data may be written and read by the first unit 101 and the second unit 102 using the RAM 24 instead of the flash memory 25.

Further, the second core 22 refers to a vehicle data conversion table 23a stored in the ROM 23, and converts each divided piece of extracted data into a control label and vehicle data.

The vehicle data conversion table 23a includes normalization information and semantic information.

The normalization information is information for normalizing the extracted data so that the same physical quantity has the same value regardless of the vehicle type and the vehicle manufacturer.

The semantic information is information for conversion into meaningful vehicle data using normalized vehicle data. Hereinafter, the normalized and semantic vehicle data is also referred to as processed data, and the vehicle data before being normalized and semantic is also referred to as raw data. The raw data refers to, for example, data indicated in a data field of a CAN frame.

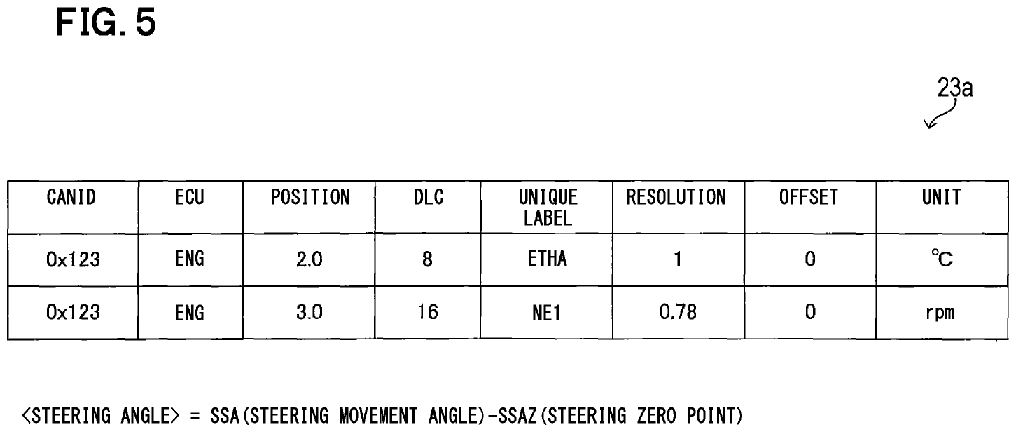

As illustrated in FIG. 5, the normalization information about the vehicle data conversion table 23a includes, for example, “CANID”, “ECU”, “position”, “DLC”, “unique label”, “resolution”, “offset”, and “unit” as setting items.

The “ECU” is information indicating an ECU of a transmission source of the CAN frame. For example, the “ENG” indicates an engine ECU.

The “position” is information indicating the position of the CAN data in the data field. The “DLC” is information indicating a data length. DLC stands for Data Length Code.

The “unique label” is information indicating a control label. For example, the “ETHA” indicates an intake air temperature, and the “NE1” indicates an engine speed. The “resolution” is information indicating a numerical value per bit.

Therefore, data corresponding to the “unique label” is extracted from the standard format data by the “CANID”, the “ECU”, the “position”, the “DLC”, and the “unique label”. Further, the extracted data is converted into vehicle data converted into a value represented by “unit” by the “resolution” and the “offset”.

For example, as illustrated in FIG. 5, the semantic information about the vehicle data conversion table 23a includes a conversion formula for converting into the “steering angle” by subtracting the “steering zero point” with the control label “SSAZ” from the “steering movement angle” with the control label “SSA”. According to this conversion formula, data is converted into vehicle data representing a “steering angle” having a meaning of a “steering amount from a reference position” from vehicle data representing a “steering movement angle” and vehicle data representing a “steering zero point”.

The second core 22 hierarchically stores the converted vehicle data in the flash memory 25. Specifically, the second core 22 stores the converted vehicle data in the corresponding area of the standardized vehicle data storage unit 25a provided in the flash memory 25.

The standardized vehicle data storage unit 25a stores standardized vehicle data configured by hierarchizing vehicle data.

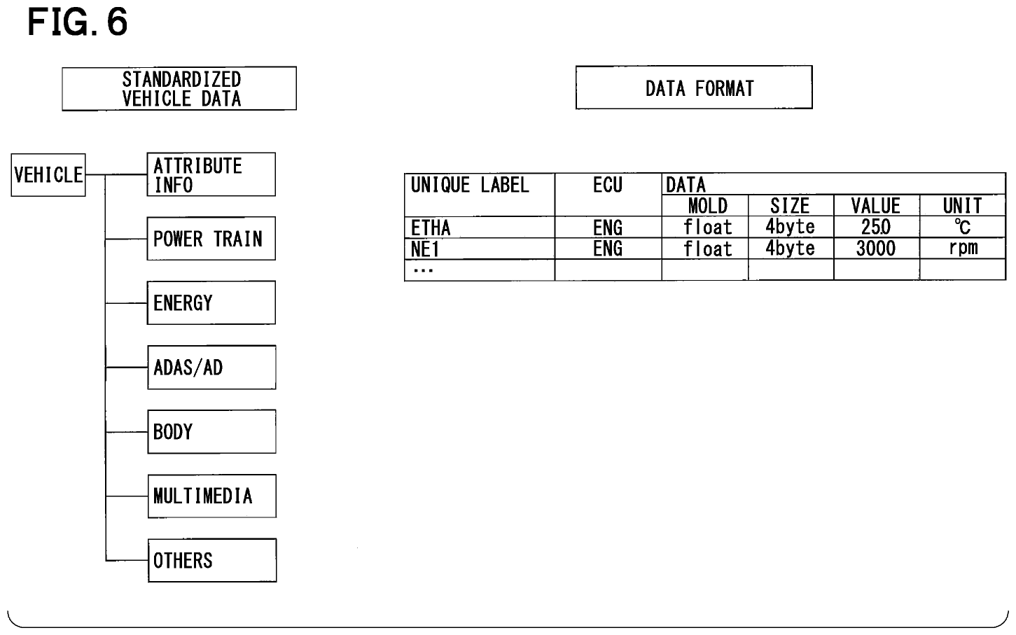

The standardized vehicle data is created for each vehicle (that is, for each edge device 2) and has a plurality of hierarchical structures. In the standardized vehicle data, one or more items are set for each of a plurality of hierarchies. For example, as illustrated in FIG. 6, the standardized vehicle data includes “attribute information”, “power train”, “energy”, “ADAS/AD”, “body”, “multimedia”, and “others” as items set in the first hierarchy at the highest level. ADAS stands for Advanced Driver Assistance System. AD stands for Autonomous Driving. The “attribute information”, the “power train”, the “energy”, and the like correspond to categories.

In addition, each vehicle data includes, as items, “unique label”, “ECU”, “data type”, “data size”, “data value”, and “data unit”. The “unique label” and the “ECU” are as described above. The “data type”, the “data size”, and the “data unit” indicate a type, size, and unit related to the numerical value indicated by the “data value”.

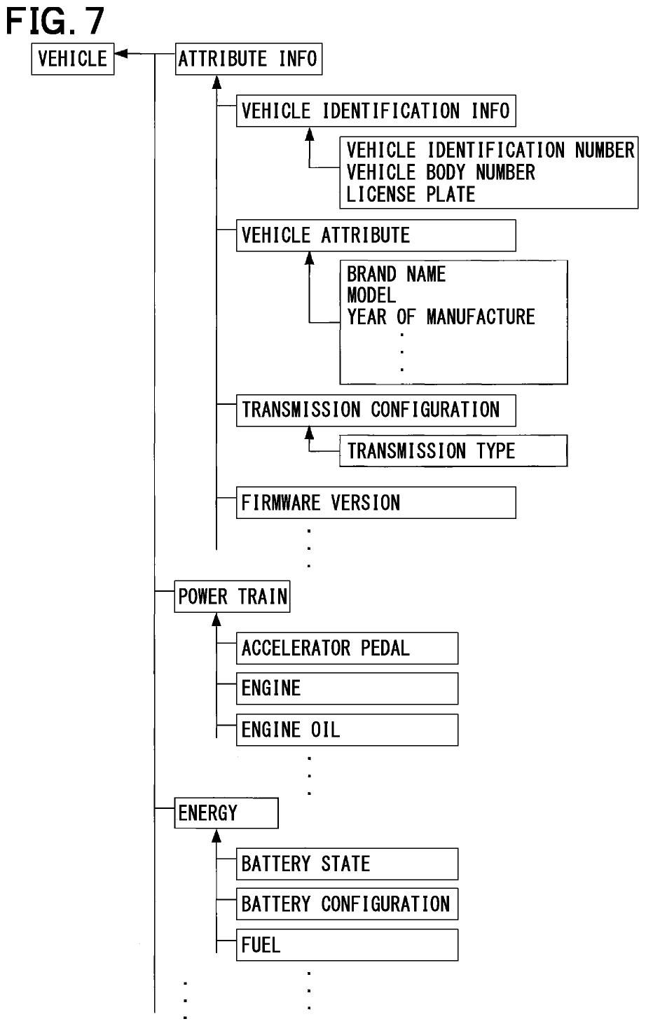

As illustrated in FIG. 7, the standardized vehicle data includes at least a second hierarchy and a third hierarchy in addition to the first hierarchy. The second hierarchy is a hierarchy immediately below the first hierarchy, and the third hierarchy is a hierarchy immediately below the second hierarchy. The standardized vehicle data is an item set in the normalization and semantic processing described above. The standardized vehicle data has a hierarchical data structure.

For example, the “attribute information” which is an item in the first hierarchy includes a “vehicle identification information”, a “vehicle attribute”, a “transmission configuration”, a “firmware version”, and the like as items in the second hierarchy. The “vehicle identification information” is a category name indicating information that can uniquely identify the vehicle. “Vehicle attribute” is a category name indicating a type of vehicle. The “transmission configuration” is a category name indicating information about the transmission. The “firmware version” is a category name indicating information related to firmware of the vehicle.

In addition, the “power train” which is an item in the first hierarchy is a category name indicating information about the power train. The “power train” includes an “accelerator pedal”, an “engine”, an “engine oil”, and the like as items in the second hierarchy. The “accelerator pedal” includes one or more pieces of vehicle data such as a state and an opening degree of the accelerator pedal. The “engine” includes one or more pieces of individual vehicle data such as an engine state and a rotation speed. Items in the second hierarchy also correspond to categories. The same applies to the items in the other first hierarchy.

In addition, the “energy” which is an item in the first hierarchy is a category name indicating information about energy. The “energy” includes a “battery state”, a “battery configuration”, “fuel”, and the like as items in a second hierarchy.

The item “vehicle identification information” in the second hierarchy includes a “vehicle identification number”, a “vehicle body number”, and a “license plate” as items in the third hierarchy. The items in the third hierarchy are one or more pieces of individual vehicle data, and are also referred to as items. That is, in the hierarchical structure of the standardized vehicle data, items in the lowermost hierarchy are referred to as items, and items in the hierarchies other than the lowermost hierarchy (that is, an item having a lower hierarchy) are referred to as categories.

Further, the “vehicle attribute” which is an item in the second hierarchy includes a “brand name”, a “model”, a “year of manufacture”, and the like as items in the third hierarchy.

The “transmission configuration” which is an item in the second hierarchy includes a “transmission type” as an item in the third hierarchy.

For example, when the control label of the converted vehicle data is “vehicle identification information”, the second core 22 stores the converted vehicle data in a storage area in which the first hierarchy is “attribute information”, the second hierarchy is “vehicle identification information”, and the third hierarchy is “vehicle identification number” in the standardized vehicle data storage unit 25a.

The “others” may include, for example, position information acquired from a GPS device mounted on the vehicle via the vehicle I/F 12, that is, latitude, longitude, and altitude.

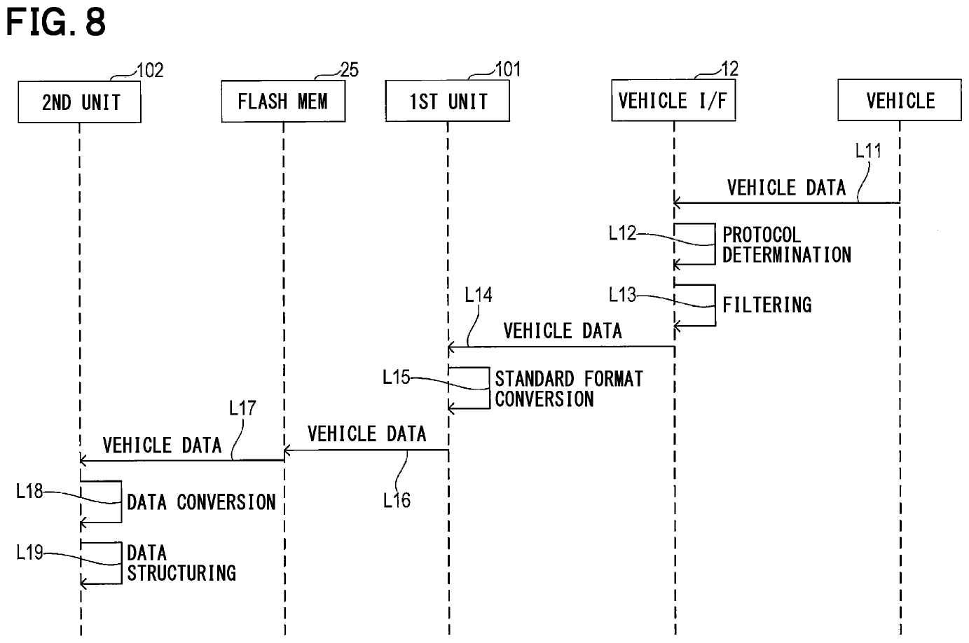

Next, a procedure in which the edge device 2 creates the standardized vehicle data will be described using the sequence diagram illustrated in FIG. 8.

As indicated by an arrow L11, when the vehicle I/F 12 acquires vehicle data from the vehicle, the vehicle I/F 12 performs communication protocol determination as indicated by an arrow L12. Further, the vehicle I/F 12 filters unnecessary vehicle data as indicated by an arrow L13 to output necessary vehicle data to the first unit 101 as indicated by an arrow L14.

When acquiring the vehicle data from the vehicle I/F 12, the first unit 101 converts the vehicle data into the standard format as indicated by an arrow L15, and stores the vehicle data converted into the standard format in the flash memory 25 as indicated by an arrow L16.

When acquiring the vehicle data converted into the standard format from the flash memory 25 as indicated by an arrow L17, the second unit 102 converts the acquired vehicle data as indicated by an arrow L18. Further, as indicated by an arrow L19, the second unit 102 creates standardized vehicle data by structuring the converted data.

Next, a procedure of data transmission processing executed by the edge device 2 will be described.

Timing information indicating a timing of transmitting data to the management center 3 is set in each vehicle data belonging to the standardized vehicle data. The timing information is set such that the cycle is shorter as the data changes more frequently and the data whose degree of importance is higher according to the degree of change of the data, the importance of the data, and the like. The timing information is, for example, a 500 ms cycle, a 2 s cycle, a 4 s cycle, a 30 s cycle, a 300 s cycle, a 12 hour cycle, or the like.

The second core 22 executes the transmission processing in a transmission unit time (for example, 250 ms) cycle.

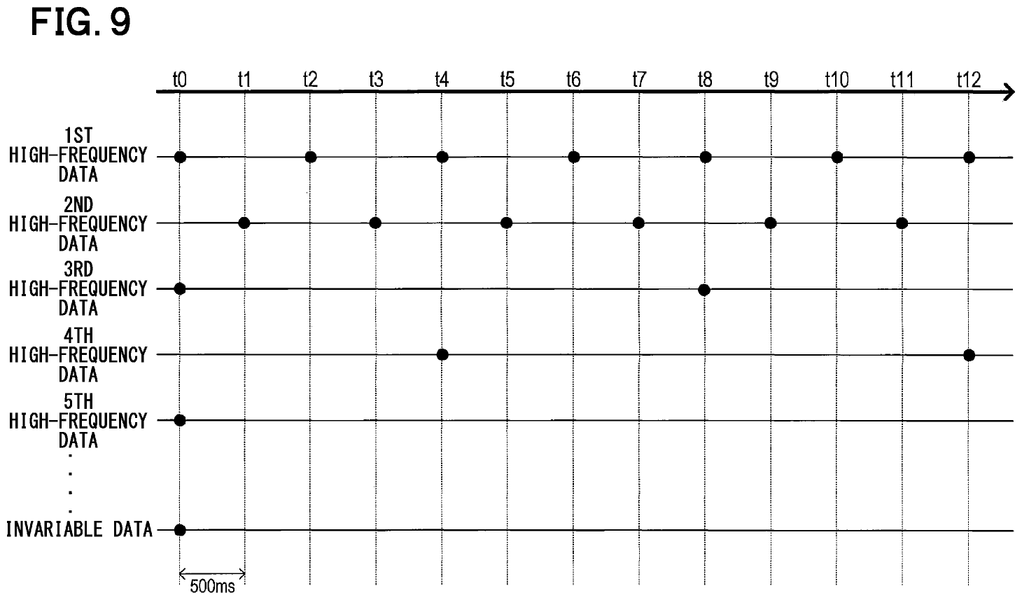

As illustrated in FIG. 9, the first frequency data, which is vehicle data to be transmitted at a cycle of 500 ms, is divided into two groups and alternately transmitted at each transmission timing. Similarly, the second frequency data, which is the vehicle data transmitted in the 1 s cycle, is divided into two groups or four groups, and the data of each group is transmitted at different transmission timings. That is, by transmitting each vehicle data according to a preset transmission schedule, it is possible to suppress the concentration of transmission of a large amount of vehicle data at the same transmission timing. In addition, efficient transmission is realized by transmitting each vehicle data at a frequency according to its characteristics.

[1-3. Management Center]

[1-3-1. Device Configuration]

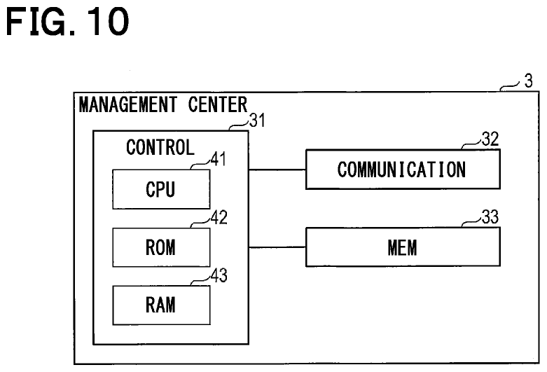

As illustrated in FIG. 10, the management center 3 includes a control unit 31, a communication unit 32, and a memory unit 33.

The control unit 31 is an electronic control device mainly including a microcomputer including a CPU 41, a ROM 42, a RAM 43, and the like. Various functions of the microcomputer are implemented by the CPU 41 executing a program stored in a non-transitory tangible recording medium. In this example, the ROM 42 corresponds to a non-transitory tangible recording medium storing a program. Further, by executing this program, a method corresponding to the program is executed. Some or all of the functions executed by the CPU 41 may be configured as hardware by one or a plurality of ICs or the like. Furthermore, the number of microcomputers constituting the control unit 31 may be one or more.

The communication unit 32 performs data communication with the plurality of edge devices 2 and the service providing server 4 via the wide area wireless communication network NW. Note that MQTT, which is a simple and lightweight protocol of a publishing/subscribing type, is used for communication with the edge device 2. MQTT stands for Message Queue Telemetry Transport.

The memory unit 33 is a storage device for storing various pieces of data.

[1-3-2. Functional Configuration]

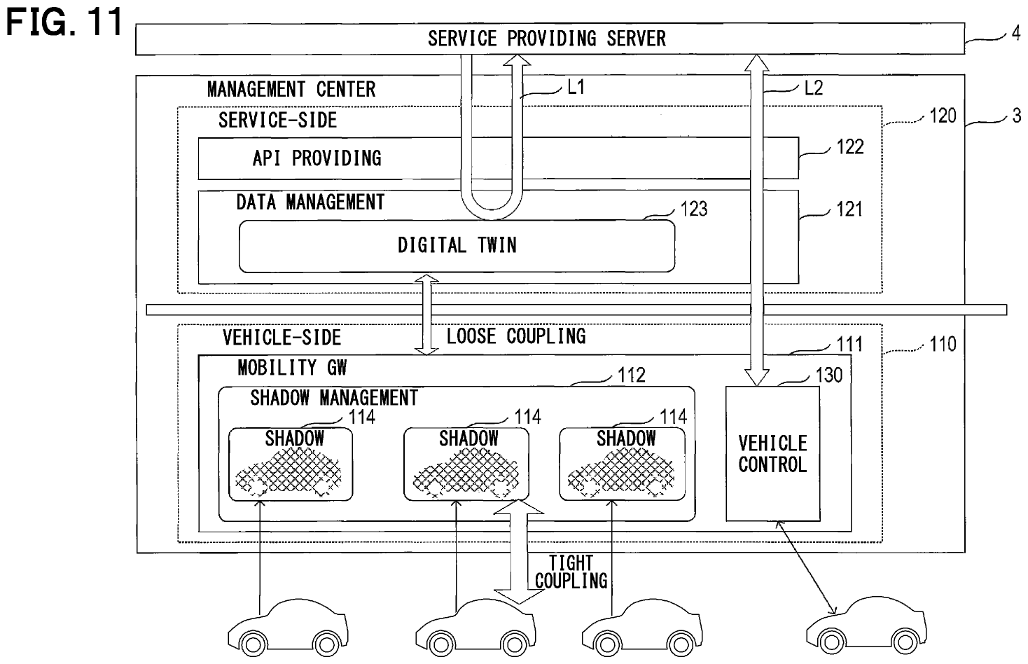

As illustrated in FIG. 11, the management center 3 includes a vehicle-side unit 110 and a service-side unit 120 as functional blocks implemented by the CPU 41 executing a program stored in the ROM 42. The functional block close to the access to the vehicle is the vehicle-side unit 110, and the functional block close to the access from the service providing server 4 is the service-side unit 120. These two functional blocks are configured to be loosely coupled.

A method for realizing these elements constituting the management center 3 is not limited to software, and some or all of the elements may be realized by using one or a plurality of pieces of hardware. For example, in a case where the above-described function is implemented by an electronic circuit which is hardware, the electronic circuit may be realized by a digital circuit including a large number of logic circuits, an analog circuit, or a combination thereof.

The vehicle-side unit 110 has a function of managing access to the vehicle and data received from the vehicle. The vehicle-side unit 110 includes a mobility gateway (hereinafter, the mobility GW) 111. The mobility GW 111 has a function of managing data received from the vehicle in addition to a function of relaying an access request to the vehicle to the vehicle.

The mobility GW 111 includes a shadow management unit 112 and a vehicle control unit 130. The shadow management unit 112 has a function of managing a shadow 114 containing vehicle data provided for each vehicle on which the edge device 2 is mounted. The shadow 114 indicates a vehicle data group of a certain vehicle. The shadow 114 is generated based on the standardized vehicle data transmitted from the edge device 2. The vehicle control unit 130 has a function of controlling the vehicle on which the edge device 2 is mounted via the edge device 2 in accordance with an instruction from the service providing server 4.

The service-side unit 120 receives a request from the service providing server 4 and provides vehicle data. The service-side unit 120 includes a data management unit 121 and an API providing unit 122. API stands for Application Programming Interface.

The data management unit 121 has a function of managing a digital twin 123, which is a virtual space for providing vehicle access independent of a change in the connection state of the vehicle. The data management unit 121 manages data necessary for accessing vehicle data managed by the vehicle-side unit 110.

The API providing unit 122 is a standard interface for the service providing server 4 to access the mobility GW 111 and the data management unit 121. The API providing unit 122 provides the service providing server 4 with an API for accessing a vehicle and acquiring vehicle data.

[1-3-2-1 Data Accumulation Function]

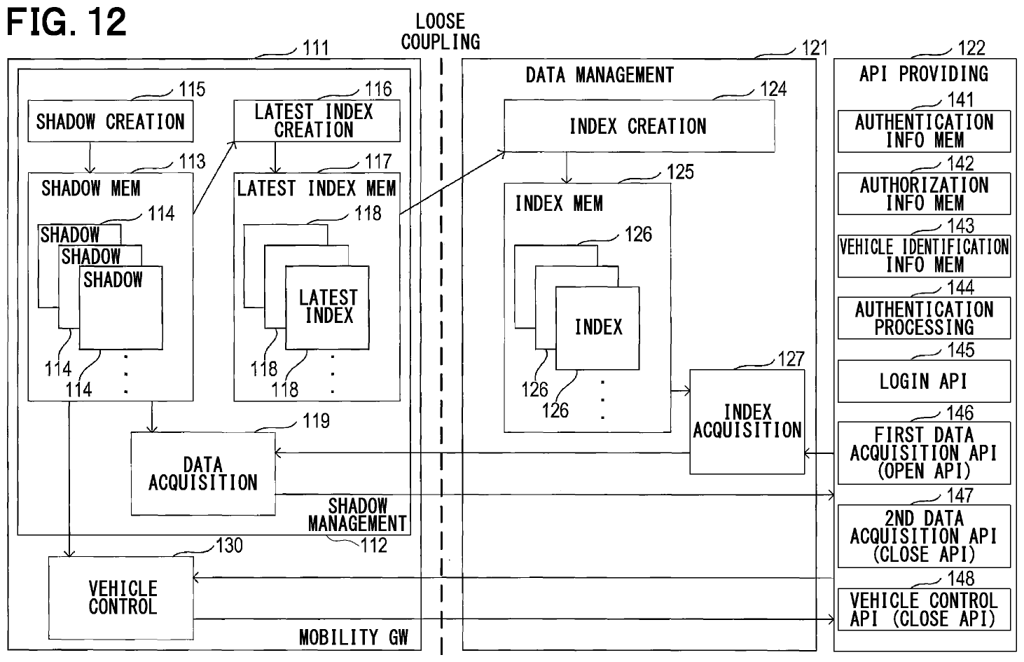

As illustrated in FIG. 12, the shadow management unit 112 includes a shadow creation unit 115, a shadow memory unit 113, a latest index creation unit 116, and a latest index memory unit 117 as a configuration for realizing a function of accumulating vehicle data acquired from the edge device 2.

The shadow creation unit 115 receives the structured standardized vehicle data from the edge device 2. Every time the vehicle data is transmitted from the edge device 2, the shadow creation unit 115 updates the standardized vehicle data by overwriting the corresponding area of the structured standardized vehicle data with the transmitted vehicle data. The shadow creation unit 115 may receive a portion of the structured standardized vehicle data. The shadow creation unit 115 creates a new shadow 114 using the updated standardized vehicle data. The shadow creation unit 115 accumulates the created shadow 114 in the shadow memory unit 113. When creating a new shadow 114 using the updated standardized vehicle data, the shadow creation unit 115 may add any information such as a serial number and store the information in the shadow memory unit 113. The shadow memory unit 113 stores a plurality of shadows 114 created in time series for each vehicle. That is, the shadow 114 can be regarded as a copy of a state at a certain time of the vehicle on which the edge device 2 is mounted.

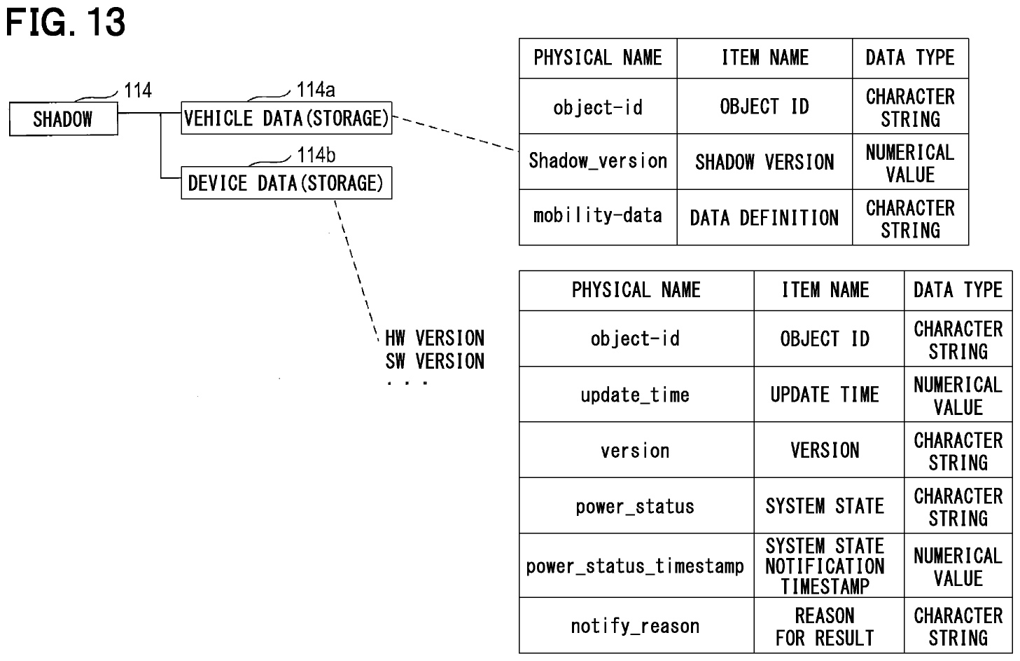

One shadow 114 is a vehicle data group of a certain vehicle at a predetermined time, and includes a vehicle data group represented by the standardized data structure illustrated in FIG. 13. Note that the timing at which the shadow creation unit 115 receives the structured standardized vehicle data via the communication unit 32 varies depending on the vehicle. The new shadow 114 may be created for all the vehicles at the same timing. The shadow creation unit 115 may create a new shadow 114 for all the vehicles at a constant cycle. The shadow memory unit 113 accumulates past shadow 114 for each vehicle. The shadow 114 after a certain period may be sequentially deleted.

As illustrated in FIG. 13, shadow 114 includes a vehicle data storage unit 114a and a device data storage unit 114b.

The vehicle data storage unit 114a stores “object-id”, “Shadow_version”, and “mobility-data” as data related to the vehicle on which the edge device 2 is mounted.

The “object-id” is a character string for identifying the vehicle on which the edge device 2 is mounted, and functions as a partition key.

The “Shadow_version” is a numerical value indicating a version of shadow 114, and a time stamp indicating a creation time is set every time shadow 114 is created.

The “mobility-data” is the above-described standardized vehicle data.

The device data storage unit 114b stores “object-id”, “update_time”, “version”, “power_status”, “power_status_timestamp”, and “notify_reason” as data regarding hardware, software, mounted on the edge device 2, and a state. The data such as “version” and “power_status” is transmitted from the edge device 2 separately from the standardized vehicle data when the value changes.

The “object-id” is the same as that described in the vehicle data storage unit 114a.

The “update_time” is a numerical value indicating an update time.

The “version” is a character string indicating versions of hardware and software of the edge device 2.

The “power_status” is a character string indicating the system state of the edge device 2. Specifically, there are a wake-up state in which all functions are available and a sleep state with low power consumption in which some functions are stopped.

The “power_status_timestamp” is a numerical value indicating the notification time of the system state.

The “notify_reason” is a character string indicating a notification reason.

As described above, the shadow 114 includes information about the edge device 2 in addition to the vehicle data group. Note that the device data storage unit 114b may store the information about the edge device 2 in the ROM 42 or the like separately without including the information about the edge device 2 in the shadow 114. The device data storage unit 114b may store only the latest data in the ROM 42 or the like instead of accumulating the past data for each time stamp as the information about the edge device 2.

The “version”, “power_status”, “notify_reason”, and the like stored in the device data storage unit 114b are notified from the edge device 2 when a change occurs, separately from the standardized vehicle data.

The latest index creation unit 116 acquires the latest shadow 114 for each vehicle from the shadow memory unit 113, and creates the latest index 118 using the acquired shadow 114. Then, the latest index creation unit 116 stores the created latest index 118 in the latest index memory unit 117. The latest index memory unit 117 stores one latest index 118 for each vehicle (that is, for each object-id).

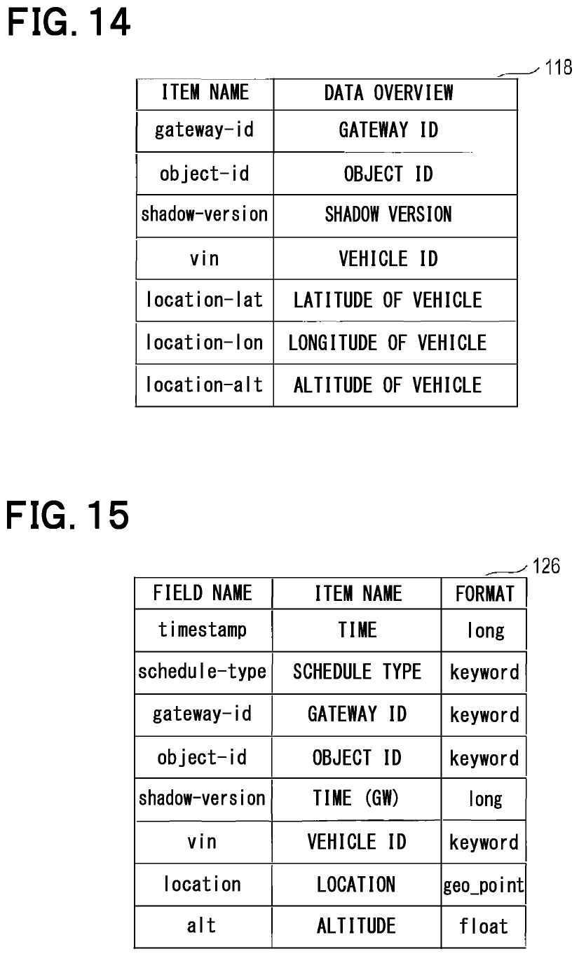

As illustrated in FIG. 14, the latest index 118 stores “gateway-id”, “object-id”, “shadow-version”, “vin”, “location-Ion”, “location-lat”, and “location-alt”.

The “object-id” and the “shadow-version” are similar to those described in the shadow 114.

The “gateway-id” is information for identifying the mobility GW 111. This is information for identifying a plurality of the management centers 3, for example, when the management centers 3 are provided for respective countries.

The “vin” is a registration number unique to the vehicle on which the edge device 2 is mounted.

The “location-lat” is information indicating the latitude at which the vehicle on which the edge device 2 is mounted is present.

The “location-Ion” is information indicating the longitude at which the vehicle on which the edge device 2 is mounted is present.

The “location-alt” is information indicating the altitude at which the vehicle on which the edge device 2 is mounted is present.

As illustrated in FIG. 12, the data management unit 121 includes an index creation unit 124 and an index memory unit 125 as a configuration that realizes a function of accumulating the latest index 118 acquired from the shadow management unit 112 as an index 126.

The index creation unit 124 acquires the latest index 118 from the latest index memory unit 117 according to a preset acquisition schedule, and creates the index 126 for the digital twin 123 using the acquired latest index 118. Then, the index creation unit 124 sequentially stores the created index 126 in the index memory unit 125. The index memory unit 125 stores a plurality of indexes 126 created in time series for each vehicle. That is, each of the indexes 126 stored in the index memory unit 125 represents a vehicle existing on the digital twin 123 which is a virtual time space.

As illustrated in FIG. 15, the index 126 stores “timestamp”, “schedule-type”, “gateway-id”, “object-id”, “shadow-version”, “vin”, “location”, and “alt”.

The “timestamp” is a timestamp indicating the time at which the index 126 is created in units of milliseconds.

The “schedule-type” indicates whether the scheduler of the data creation source is a periodic scheduler or an event. In a case where it is periodic, the “schedule-type” is set to “Repeat”, and in a case where it is an event, the “schedule-type” is set to “Event”.

The “gateway-id”, the “object-id”, the “shadow-version”, and the “vin” are information taken over from the latest index 118.

The “location” is information taken over from the “location-Ion” and the “location-lat” of the latest index 118, and the “alt” is information taken over from the “location-alt” of the latest index 118.

Here, the shadow management unit 112 may have a configuration in which the latest index creation unit 116 and the latest index memory unit 117 are omitted. In this case, the index creation unit 124 may acquire the shadow 114 stored in the shadow memory unit 113 and generate the index 126. Preferably, the index creation unit 124 generates the index 126 by using the latest index 118 acquired from the latest index memory unit 117. This is one of configurations in which the mobility GW 111 and the data management unit 121 are loosely coupled.

Further, the data management unit 121 may have a configuration in which the index creation unit 124 and the index memory unit 125 are omitted. In this case, for example, the index acquisition unit 127 may request the data acquisition unit 119 to acquire the designated vehicle data using the object-id and the timestamp (that is, shadow-version) designated via the API providing unit 122.

[1-3-2-2. Service Providing Function]

As illustrated in FIGS. 5 and 12, the service-side unit 120 includes the API providing unit 122. The API providing unit 122 is an interface prepared for allowing an external service provider such as the service providing server 4 to use the function of the management center 3. Hereinafter, the user of the mobility IoT system 1 using the API providing unit 122 or the like is referred to as a service user. The service user is, for example, a service operator that performs home delivery to a vehicle trunk.

As illustrated in FIG. 12, the API providing unit 122 includes an authentication information memory unit 141, an authorization information memory unit 142, a vehicle identification information memory unit 143, and an authentication processing unit 144. In addition, a login API 145, a first data acquisition API 146, a second data acquisition API 147, and a vehicle control API 148 are included as the types of APIs provided to the service user.

The login API 145 is an API provided for authenticating the service user. The first data acquisition API 146 and the second data acquisition API 147 are APIs provided for the service user to acquire data. The vehicle control API 148 is an API provided for the service user to control the vehicle.

The authentication information memory unit 141 stores “authentication information” in association with the “service user ID”. The “service user ID” is identification information for uniquely identifying the service user. The “authentication information” is information for authenticating the service user himself/herself, and is, for example, a password set in advance.

The authorization information memory unit 142 includes an authorization object database (hereinafter, an authorization object DB) and an authorization class DB.

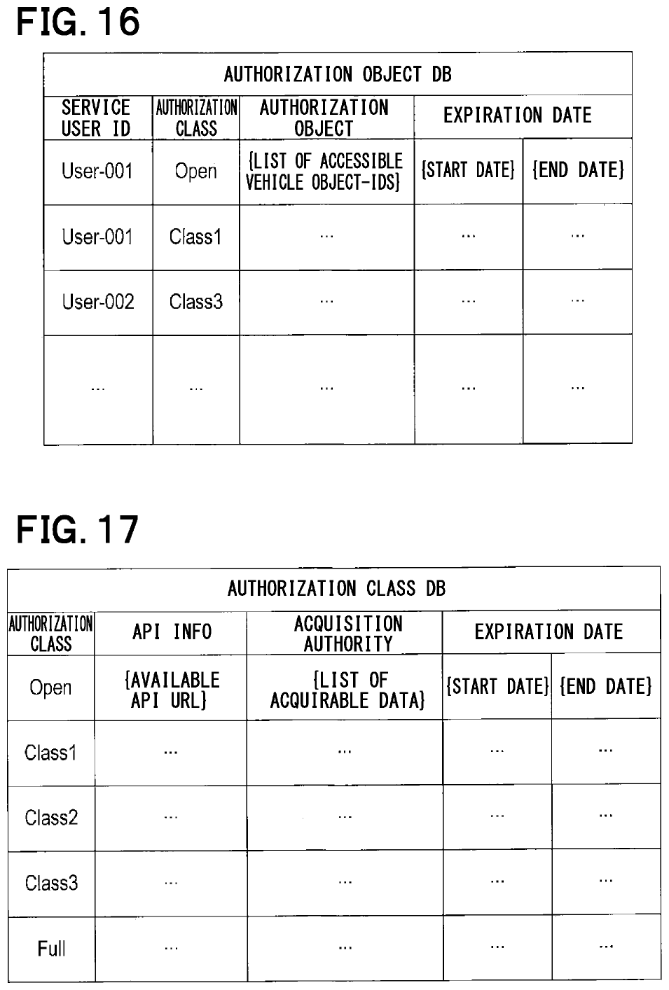

As illustrated in FIG. 16, the authorization object DB stores an “authorization class”, an “authorization object”, and an “expiration date” in association with the “service user ID”. The “authorization class” is information indicating a range of authority authorized for the service user. The “authorization object” is a list of “object-ids” of a vehicle that is allowed to be accessed by the service user. The “expiration date” is the start date and the end date of the period in which the registration content is valid. That is, the authorization object DB is a database indicating registration content regarding the authority of each service user with respect to the mobility IoT system 1. In the authorization object DB, a plurality of registrations may be performed for one service user as long as the “authorization objects” are different or the “expiration dates” do not overlap.

As illustrated in FIG. 17, the authorization class DB stores “API information”, “acquisition authority”, and “expiration date” in association with the “authorization class”. The authorization class DB is a database representing specific content of the “authorization class”.

The “authorization class” is information for identifying a plurality of classes representing a data range to be authorized, and for example, there may be six classes of “open”, “Class0”, “class1”, “class2”, “class3”, and “Full” in ascending order of the authorization class. The “authorization class” is not limited to classification of a data range in which data can be read or written, and may be classification of an operation control range in which operation can be controlled.

The “API information” is a url of the API provided to the service user of the corresponding “authorization class”. url stands for Uniform Resource Locator.

The “acquisition authority” is a list of acquirable data permitted for the corresponding “authorization class” service user. When the authorization class is “open”, the data included in the “acquisition authority” is limited to information that is allowed to be freely accessed by anyone, and may include, for example, position information and altitude information about the vehicle. When the authorization class is “Full”, the data included in the “acquisition authority” includes all the information managed by the management center 3 and all the information that is allowed to be acquired from the vehicle on which the edge device 2 is mounted. In a case where the authorization class is “Class0” to “Class3”, the number of accessible data may be set to increase as the class increases to 0 to 3, or the type of accessible data may be set to be different for each class.

Here, the acquirable data is listed as the acquisition authority, but instead of the acquirable data or in addition to the acquirable data, the available function, for example, the type of control for the vehicle on which the edge device 2 is mounted, and the like may be listed. The acquirable data is listed from the data items illustrated in FIG. 7, for example.

When the “expiration date” does not overlap, there may be a plurality of settings in one “authorization class”.

The vehicle identification information memory unit 143 stores table information in which “object-id” uniquely assigned to the vehicle on which the edge device 2 is mounted is associated with “vin” of the vehicle.

The authentication processing unit 144 executes an authentication process when an authentication request is made via the login API 145, and executes an authorization process when an access request is made via the first data acquisition API 146, the second data acquisition API 147, and the vehicle control API 148. The authentication process and the authorization process will be described later.

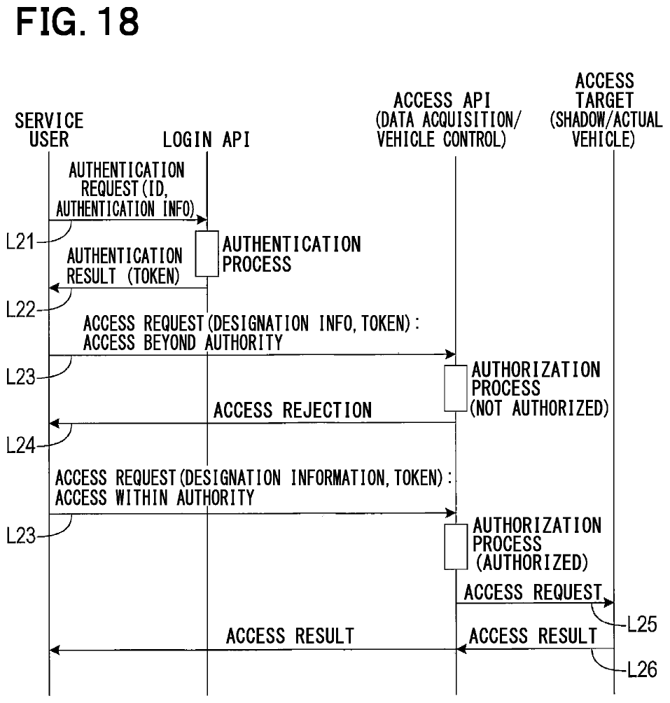

A procedure related to an access request via the API providing unit 122 will be described with reference to FIG. 18.

The login API 145 is used when the service user logs in to the mobility IoT system 1.

As indicated by an arrow L21, when the login API 145 receives an authentication request from the service user, the authentication processing unit 144 executes an authentication process. In the authentication process, the “service user ID” and the “authentication information” input by the login API 145 are collated with the registration content of the authentication information memory unit 141. As a result of the collation, in a case where the information is matched, that is, in a case where the authentication is successful, as indicated by an arrow L22, a token which is data serving as a certificate for permitting access to the mobility IoT system 1 is returned as the authentication result.

The first data acquisition API 146 is one of open APIs used for accessing information or the like with low confidentiality. The second data acquisition API 147 is one of close APIs used when accessing information or the like with high confidentiality. The vehicle control API 148 is one of close APIs used when controlling the vehicle on which the edge device 2 is mounted.

Regarding the acquisition of data from the cloud, acquisition of highly confidential data may be provided by the close API, and acquisition of less confidential data may be provided by the open API. Regarding the data acquisition from the vehicle, acquisition of highly confidential data may be provided by the close API, and acquisition of less confidential data may be provided by the open API. Regarding the vehicle control, control related to traveling of the vehicle may be provided by the close API, and control not related to traveling of the vehicle may be provided by the open API.

Here, as indicated by an arrow L1 in FIG. 11, the first data acquisition API 146, which is an open API, is used to access the vehicle data (that is, index 126 and shadow 114) accumulated in the management center 3. In addition, as indicated by an arrow L2 in FIG. 11, the second data acquisition API 147 and the vehicle control API 148, which are close APIs, are used to access the vehicle on which the edge device 2 is mounted. However, the close API may be used for part (that is, highly confidential information and the like) of the vehicle data accumulated in the management center 3.

Hereinafter, the first data acquisition API 146, the second data acquisition API 147, and the vehicle control API 148 are collectively referred to as an access API. As indicated by an arrow L23 in FIG. 18, when the access API receives an access request from a service user, the authentication processing unit 144 executes an authorization process.

When the authorization process is executed, the authentication processing unit 144 identifies the “service user ID” from the “token” added to the access request. Next, the authentication processing unit 144 identifies the “authorization class” and the “authorization object” of the identified “service user ID” by searching the authorization object DB of the authorization information memory unit 142. Further, the authentication processing unit 144 determines whether the vehicle to be accessed indicated in the access request is indicated in the “authorization object”, that is, whether access to the vehicle designated by the service user is permitted. In addition, the authentication processing unit 144 refers to the authorization class DB and determines whether the access API used for the access request is included in the “API information” of the designated “authorization class”, that is, whether use of the API designated by the service user is permitted. Further, the authentication processing unit 144 refers to the authorization class DB and determines whether the instruction content indicated in the access request is within the range of the “acquisition authority” of the identified “authorization class”, that is, whether access to the instruction content requested by the service user is permitted. Then, in a case where the vehicle to be accessed is not indicated in the “authorization object”, in a case where the access API is not included in the “API information”, or in a case where the instruction content is out of the range of the “acquisition authority”, the authentication processing unit 144 determines that the vehicle to be accessed is unauthorized. When it is determined as unauthorized, the authentication processing unit 144 notifies the service user of the access rejection via the access API as indicated by an arrow L24. When the vehicle to be accessed is indicated in the “authorization object”, the access API is included in the “API information”, and the instruction content is within the range of the “acquisition authority”, the authentication processing unit 144 determines that the vehicle is authorized. When it is determined as authorized, the authentication processing unit 144 transfers the access request to the access target as indicated by an arrow L25. Specifically, in a case where the access API is an open API such as the first data acquisition API 146, the access request is transferred to the shadow 114 to be accessed. When the access API is a close API such as the second data acquisition API 147 and the vehicle control API 148, the access request is transferred to the real vehicle to be accessed. Thereafter, as indicated by an arrow L26, the access result returned from the access target is provided to the service user via the access API.

In the access API, either “object-id” or “vin” may be used as the information for identifying the vehicle. When “vin” is used, “vin” may be converted into “object-id” with reference to vehicle identification information memory unit 143.

As illustrated in FIG. 12, the management center 3 includes an index acquisition unit 127, a data acquisition unit 119, and a vehicle control unit 130 as a configuration for realizing the access request via the access API. The index acquisition unit 127 implements a function of acquiring data from the index 126 accumulated in the index memory unit 125. Data acquisition unit 119 implements a function of acquiring data from shadow 114 accumulated in shadow memory unit 113. The vehicle control unit 130 implements a function of accessing the vehicle on which the edge device 2 is mounted using the communication function with the edge device 2.

That is, an access request (hereinafter, the first data acquisition request) input via the first data acquisition API 146 which is an open API is processed by the index acquisition unit 127. In addition, an access request (hereinafter, the second data acquisition request) input via the second data acquisition API 147 which is the close API and an access request (hereinafter, vehicle control request) input via the vehicle control API 148 are processed by the vehicle control unit 130.

[1-3-3. First Data Acquisition Process]

A first data acquisition process, which is a series of processes executed when the first data acquisition API 146 receives the first data acquisition request, will be described. Specifically, it is a first data acquisition process when an access request is transmitted from the access API to the access target after the authentication process and the authorization process are performed in FIG. 18. The first data acquisition process is a process of acquiring designated data from the shadow 114 managed in the management center 3 using the first data acquisition API 146.

First, the designation information included in the first data acquisition request will be described. The designation information is set by the service user.

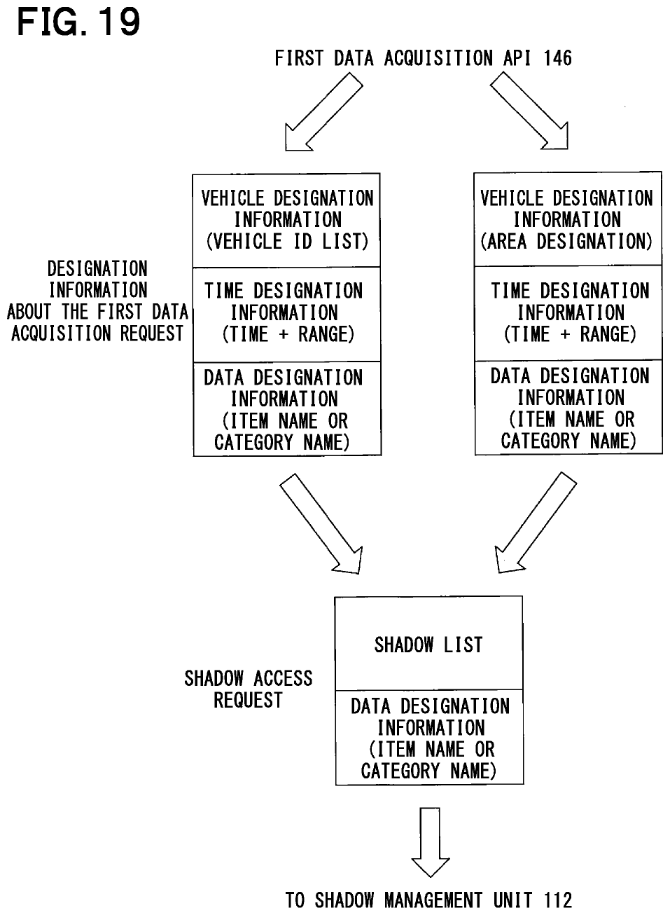

As illustrated in FIG. 19, the designation information includes vehicle designation information, time designation information, and data designation information.

The vehicle designation information is information for designating a vehicle (hereinafter, target vehicle) from which data is to be acquired. The vehicle designation information includes a method of listing vehicle IDs (that is, object-id or yin) of target vehicles in a list form and a method of designating (hereinafter, area designation) a geographical area where the target vehicles are present. In addition, the target vehicle may be designated by a vehicle type, a model, or the like.

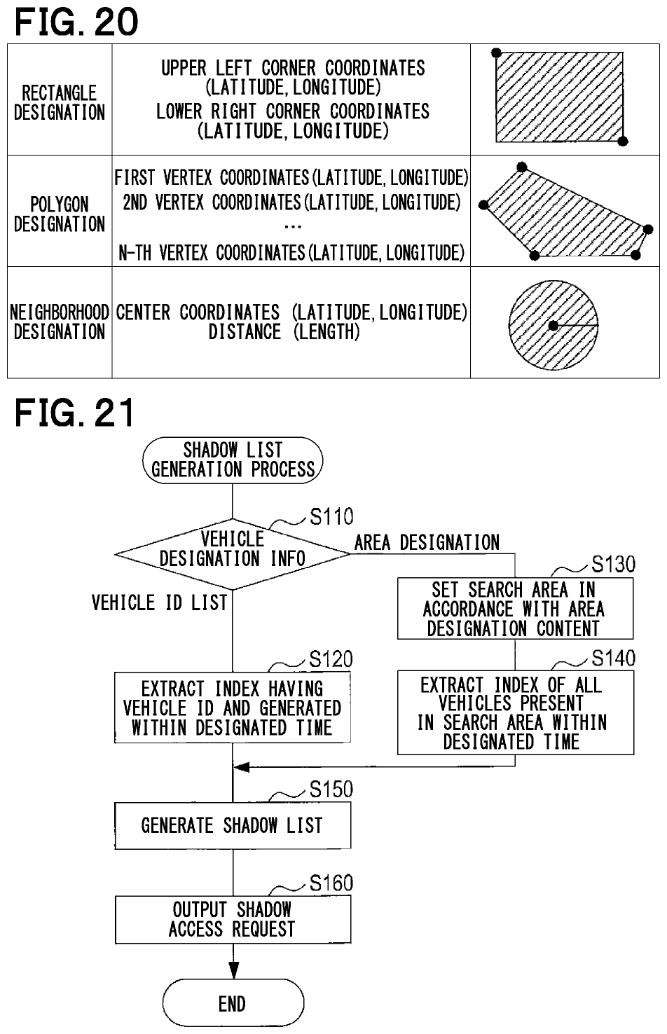

As illustrated in FIG. 20, there are three types of area designation methods: rectangle designation, polygon designation, and neighborhood designation. The rectangle designation is a method of designating a rectangular geographical area by upper left corner coordinates and lower right corner coordinates. The coordinates are represented using latitude and longitude. The polygon designation is a method of identifying a geographical area of a polygon by coordinates of n vertices of the polygon. The neighborhood designation is a method of designating a circular geographical area by the center coordinates and a distance from the center coordinates.

Returning to FIG. 19, the time designation information is information for designating a timing at which data is generated. The time designation information is represented by a starting time and a range. The range is, for example, a value in which a time width is represented by an integer of 1 or more with a generation cycle of the latest index 118 as a unit time.

The data designation information is information for designating data to be acquired. The data designation information may represent the item name of the data indicated in the standardized vehicle data in a list form, or may be represented by designating the category name indicated in the standardized vehicle data. When the category name is designated, all items belonging to the category are designated. In addition, in a case where neither the item name nor the category name is designated, all the items are designated. The data that is allowed to be designated by the item name may include raw data that is not included in the standardized vehicle data. For example, the data designation information may include a CANID of a CAN frame associated with raw data.

Note that the way of setting the vehicle designation information, the time designation information, and the data designation information described here is an example, and the method is not limited to the above method.

Next, the shadow list generation process executed by the index acquisition unit 127 when the first data acquisition API 146 receives the first data acquisition request will be described with reference to a flowchart of FIG. 21.

In S110, the index acquisition unit 127 refers to the vehicle designation information indicated in the first data acquisition request, and when the designation information is the vehicle ID list, the process proceeds to S120, and when the designation information is the area designation, the process proceeds to S130.

In S120, the index acquisition unit 127 refers to the index memory unit 125 to extract all the indexes 126 having the “object-id” indicated in the vehicle ID list and having the “timestamp” within the time range indicated by the time designation information, and advances the process to S150.

In S130, the index acquisition unit 127 sets a search area for searching for the target vehicle according to the area designation indicated in the designation information.

In subsequent S140, the index acquisition unit 127 refers to the index memory unit 125, extracts all the indexes 126 having the “location” in the search area set in S130 and having the “timestamp” within the time range indicated by the time designation information, and advances the process to S150.

In S150, the index acquisition unit 127 generates shadow identification information in which the “object-id” and the “shadow_ersion” indicated by the index 126 are combined for each of the indexes 126 extracted in S120 or S140. The generated shadow identification information is a component of a shadow identification information list (hereinafter, the shadow list) listing the shadow identification information.

In subsequent S160, the index acquisition unit 127 outputs a shadow access request in which the data designation information indicated in the first data acquisition request is added to the shadow list generated in S150 to the data acquisition unit 119 of the shadow management unit 112, and ends the process.

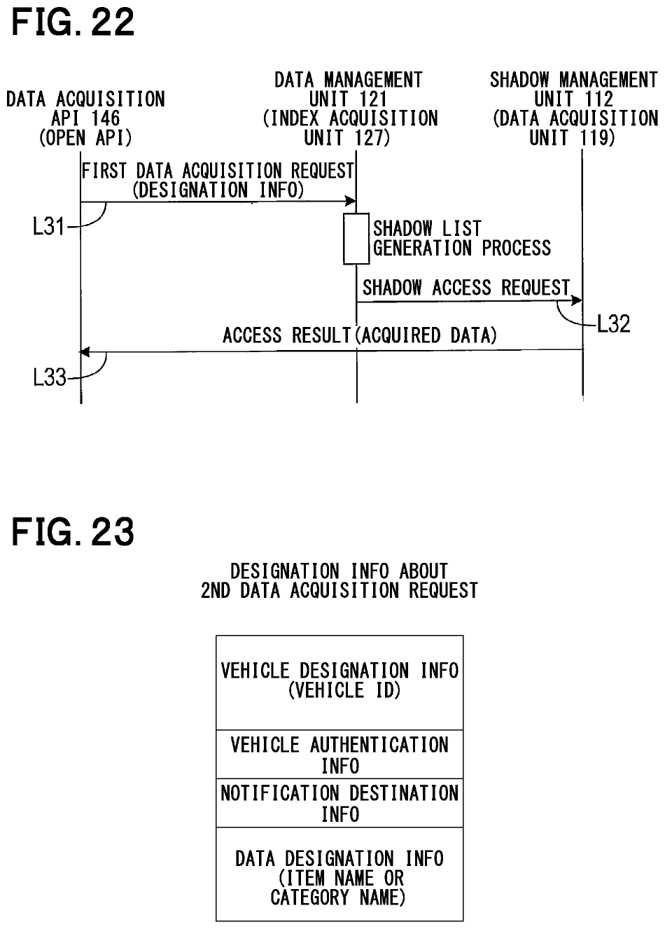

As illustrated in FIG. 22, when receiving a first data acquisition request from the first data acquisition API 146 as indicated by an arrow L31, the index acquisition unit 127 generates a shadow list. The shadow list is generated according to the acquisition condition using the vehicle designation information and the time designation information indicated in the first data acquisition request as the acquisition condition. In addition, as indicated by an arrow L32, the index acquisition unit 127 outputs a shadow access request in which the generated shadow list and the data designation information are combined to the data acquisition unit 119.

When the shadow access request from the index acquisition unit 127 is input, the data acquisition unit 119 refers to the shadow memory unit 113 and extracts the shadow 114 corresponding to each shadow identification information indicated in the shadow list of the shadow access request. Further, the data acquisition unit 119 extracts designation data, which is data indicated in the data designation information about the shadow access request, from each of the extracted shadows 114. As indicated by an arrow L33, the data acquisition unit 119 returns the extracted designation data as an access result to the first data acquisition API 146 as a request source.

[1-3-4. Second Data Acquisition Process]

A second data acquisition process, which is a series of processes executed when the second data acquisition API 147 receives a data acquisition request (hereinafter, the second data acquisition request), will be described. Specifically, it is a second data acquisition process when an access request is transmitted from the access API to the access target after the authentication process and the authorization process are performed in FIG. 18. The second data acquisition process is a process of designating a vehicle and acquiring designated data from the designated vehicle.

First, the designation information included in the second data acquisition request will be described.

As illustrated in FIG. 23, the designation information includes vehicle designation information, vehicle authentication information, notification destination information, and data designation information.

One vehicle ID is indicated in the vehicle designation information.

The vehicle authentication information is information for authenticating the vehicle on which the edge device 2 is mounted, and includes an owner ID and a vehicle password assigned to the vehicle owner. The vehicle authentication information is held by the vehicle and also held by a service user who is permitted to access the vehicle.

The notification destination information is address information (for example, url) indicating a notification destination of the encryption information used for decrypting the encrypted access result (that is, the encrypted text).

The data designation information is similar to that described in the designation information included in the first data acquisition request. However, the data that is allowed to be designated by the item name may include raw data that is not included in the standardized vehicle data. For example, the data designation information may include a CANID of a CAN frame associated with raw data.

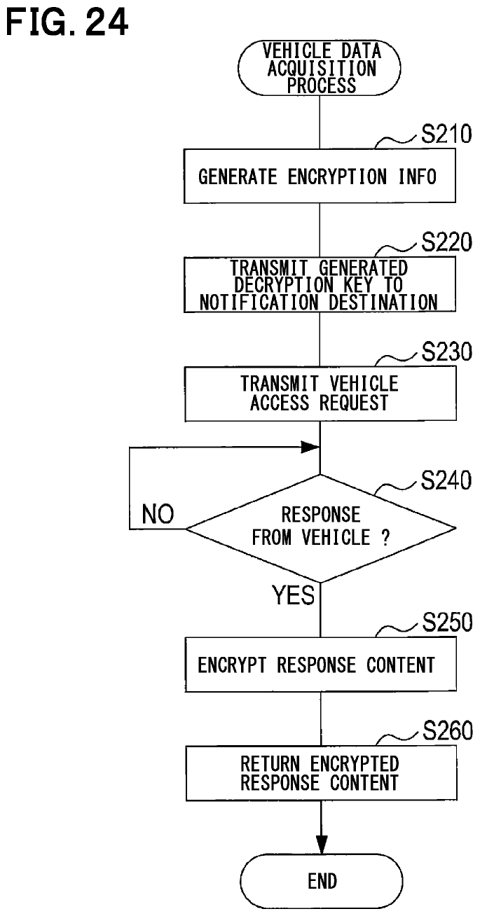

Next, the vehicle data acquisition process executed by the vehicle control unit 130 when the second data acquisition API 147 receives the second data acquisition request will be described with reference to a flowchart of FIG. 24.

In S210, the vehicle control unit 130 generates encryption information used for encrypting data and decrypting the encrypted data. As the encryption information, the same key (that is, the common key) may be used for encryption and decryption, or different keys (that is, the encryption key and the decryption key) may be used.

In subsequent S220, the vehicle control unit 130 transmits the encryption information generated in S210, in particular, the key used for decryption (that is, the common key or the decryption key) to the notification destination (for example, a url designated by the service user who is the source of the second data acquisition request) indicated in the notification destination information about the second data acquisition request.

In subsequent S230, the vehicle control unit 130 generates a vehicle access request obtained by removing the notification destination information from the designation information about the second data acquisition request to transmit the vehicle access request to the target vehicle that is the vehicle having the vehicle ID indicated in the vehicle designation information via the communication unit 32.

In subsequent S240, the vehicle control unit 130 determines whether there is a response to the vehicle access request from the target vehicle via the communication unit 32, and if there is no response, this step is repeated to stand by, and if there is a response, the process proceeds to S250. The vehicle access request here is a data acquisition request from the vehicle, and is processed by the edge device 2 in the vehicle. After performing the authentication process, the edge device 2 acquires vehicle data corresponding to the data designation information from the edge device 2 itself, the ECUs 210, 220, 230 connected via the vehicle I/F 12, or the like. The edge device 2 transmits the acquired vehicle data to the management center 3 via the communication unit 13. When the vehicle data cannot be acquired from the ECUs 210, 220, 230 or the like, an error is transmitted to the management center 3. The vehicle control unit 130 receives the data as a response from the vehicle.

In S250, the vehicle control unit 130 encrypts the response content from the vehicle with the key (that is, the common key or the encryption key) used for encryption generated in S210, returns the encrypted response content to the second data acquisition API 147 as the request source, and ends the process. Note that the response content from the vehicle may include, for example, data designated by the data designation information, a notification indicating that authentication in the vehicle has failed, and the like.

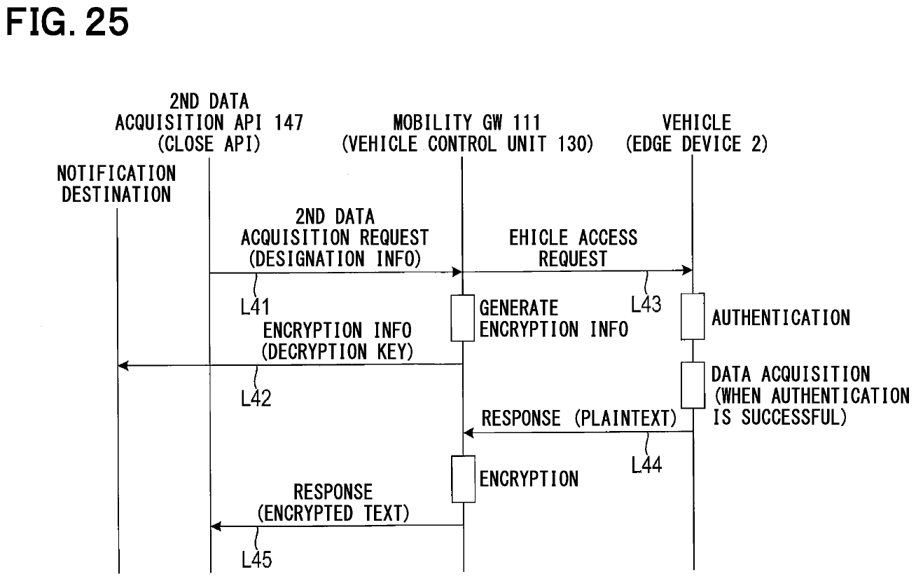

As illustrated in FIG. 25, when the second data acquisition request is input from the second data acquisition API 147 as indicated by an arrow L41, the vehicle control unit 130 generates encryption information. Then, as indicated by an arrow L42, the vehicle control unit 130 transmits the generated decryption key to the notification destination indicated in the second data acquisition request. At the same time, as indicated by an arrow L43, the vehicle control unit 130 transmits a vehicle access request obtained by excluding the notification destination information from the designation information about the second data acquisition request to the vehicle. That is, the vehicle control unit 130 transmits the decryption key to the notification destination at the stage of transmitting the vehicle access request to the vehicle.

When the edge device 2 mounted on the vehicle having the vehicle ID indicated in the vehicle designation information receives the vehicle access request, the edge device 2 collates the vehicle authentication information indicated in the vehicle access request with the vehicle authentication information about the host vehicle to perform authentication.

When the authentication fails, the edge device 2 transmits a response including a notification indicating the failure to the management center 3.

When the authentication is successful, the edge device 2 acquires the designation data indicated in the data designation information from the vehicle as indicated by an arrow L44 to transmit a response including the acquired designation data to the management center 3. The designation data may be data included in the edge device 2 or may be data acquired from another electronic control device via the vehicle I/F 12. When the designation data cannot be acquired, the edge device 2 transmits a response including a notification indicating an acquisition failure to the management center 3.

Upon receiving the response, the vehicle control unit 130 encrypts the response content and returns the encrypted response content to the second data acquisition API 147 as indicated by an arrow L45.

The service user who has made the second data acquisition request can be aware of the response content by decrypting the encrypted response content acquired via the second data acquisition API 147 using the decryption key sent to the notification destination. Here, the notification destination to which the decryption key is sent may be the second data acquisition API 147 itself. Furthermore, the vehicle control unit 130 may transmit the encrypted response content to the notification destination.

In the vehicle control API 148, by using the control designation information instead of the data designation information, it is possible to control the vehicle via the edge device 2 by a process similar to a series of processes by the second data acquisition API 147. The control designation information is information for controlling an actuator or the like of the vehicle, and it is designated which actuator to control how. For example, the door can be locked or unlocked by transmitting an instruction to an electronic control device that controls door locking via the vehicle I/F of the edge device. When receiving the vehicle access request via the communication unit 13, the edge device 2 performs an authentication process. Thereafter, when the execution completion or the execution failure is notified from the ECUs 210, 220, 230 or the like connected via the vehicle I/F 12, the edge device 2 transmits a response including a notification indicating the execution completion or the execution failure to the management center 3.

[1-4. Correspondence of Terms]

In the embodiment described above, the mobility IoT system 1 corresponds to a mobility service providing system, the management center 3 corresponds to a mobility service providing server, and the edge device 2 corresponds to an in-vehicle device. The shadow memory unit 113 corresponds to a first database, and the index memory unit 125 corresponds to a second database. The API providing unit 122 corresponds to an interface unit. The service user ID and the token correspond to user identification information. A function of performing the authorization process in the authentication processing unit 144 corresponds to the authorization unit. The processing of S210 to S220 corresponds to an encryption information generation unit, and the processing of S250 to S260 corresponds to an encryption unit. The first data acquisition request corresponds to a first access request, and the second data acquisition request and the vehicle control request correspond to a second access request.

[1-5. Effects]

According to the embodiment described in detail above, the following effects are obtained.
(1a) According to the mobility IoT system 1, the service user can acquire the vehicle data of the target vehicle from which data is to be acquired from the shadow 114 of the target vehicle using the first data acquisition API 146 which is an open API. That is, any vehicle data belonging to the standardized vehicle data can be acquired regardless of the state of the target vehicle. Further, the service user can acquire the vehicle data of the target vehicle directly from the target vehicle using the second data acquisition API 147 which is the close API. In this case, not only vehicle data belonging to the standardized vehicle data but also raw data not included in the standardized vehicle data can be acquired. In addition, real-time data can be acquired instead of past data stored in shadow 114. Therefore, flexible information provision according to the request of the service user can be realized.
(1b) In the close APIs 147, 148, the response from the access destination is encrypted and provided to the service user, and the decryption key is transmitted to the transmission destination designated by the service user. Therefore, by using the close APIs 147, 148, it is possible to safely acquire highly confidential information and to safely control the target vehicle.
(1c) In the access APIs 146 to 148, the access authority (that is, the authorization class and the authorization object) of the service user is confirmed, and access other than the authority is denied. Therefore, flexible service provision according to the service user can be realized.
(1d) When data is acquired from the shadow 114 using the first data acquisition API 146, shadow identification information is generated from the index 126 extracted by searching the digital twin 123 using the vehicle designation information and the time designation information. Therefore, it is possible to easily acquire any vehicle data of a specific vehicle from the present to the past, vehicle data of a vehicle existing in the designated area at the designated time, and the like. As a result, the vehicle data acquired by the first data acquisition API 146 can be used for, for example, a service for analyzing or predicting a traffic volume.

### 2. Second Embodiment

[2.-1. Difference from First Embodiment]

Since the basic configuration of the second embodiment is similar to that of the first embodiment, differences will be described below. Note that the same reference numerals as those in the first embodiment indicate the same configuration, and reference is made to the preceding description.

In the first embodiment described above, the mechanism for processing the authorization for the access request using the API by the management center 3 is described. On the other hand, in the second embodiment, a mechanism in which at least one of the management center 3 and the edge device 2 processes the authorization for the access request (that is, the second data acquisition request and the vehicle control request) to the vehicle using the API will be described.

[2.-2. Management Center]

The management center 3 includes a server-side authorization DB instead of the authorization object DB and the authorization class DB. The server-side authorization DB is provided in, for example, the authorization information memory unit 142 illustrated in FIG. 12.

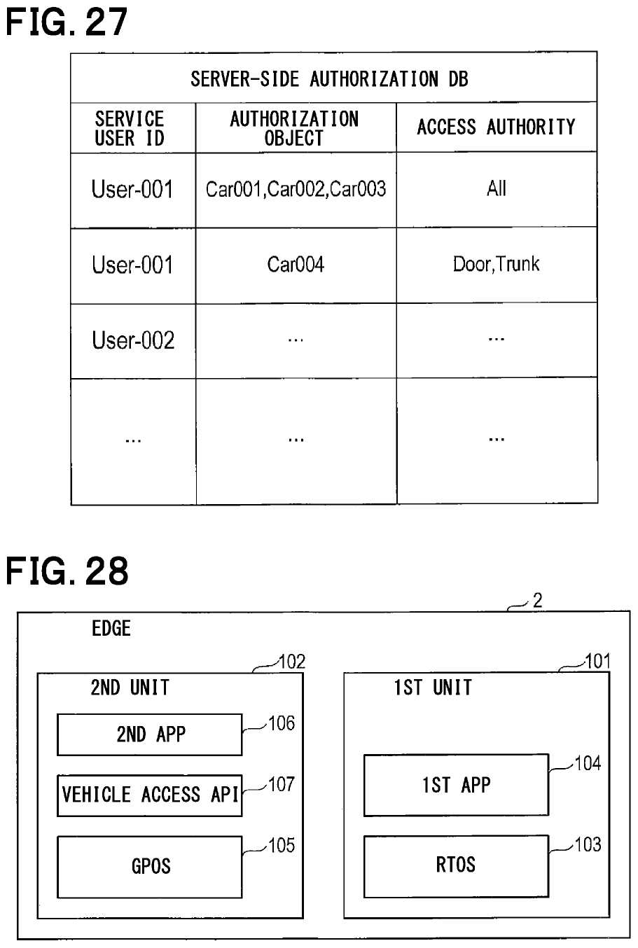

As illustrated in FIG. 27, the server-side authorization DB stores the “authorization object” and the “access authority” in association with the “service user ID”. The “service user ID” and the “authorization object” are similar to those described in the authorization object DB. The “access authority” is a list of access targets permitted to be accessed by the service user identified by the “service user ID” for the vehicle identified by the “authorization object”. The “access authority” includes, for example, “Door”, “Trunk”, “ALL”, and the like. The “Door” indicates that there is access authority to unlock and lock the door. The “Trunk” indicates that there is access authority to open or close the trunk. The “ALL” indicates that there is access authority for all access targets that the vehicle is allowed to provide.

In the server-side authorization DB, for each service user serving as a provider of the mobility service, an access authority of the service user regarding the vehicle access request, that is, information that defines an accessible range by the vehicle access request is set.

[2-3. Edge Device]

As illustrated in FIG. 28, in the second embodiment, the second unit 102 of the edge device 2 includes a vehicle access API 107 in addition to the GPOS 105 and the second application 106.

The vehicle access API 107 receives a vehicle access request from the management center 3 and executes an authorization process (hereinafter, vehicle-side authorization process) on the vehicle side. In addition, the edge device 2 includes a vehicle-side authorization DB used for the vehicle-side authorization process. The vehicle-side authorization DB is provided in, for example, the memory unit 14 or the flash memory 25 illustrated in FIG. 2.

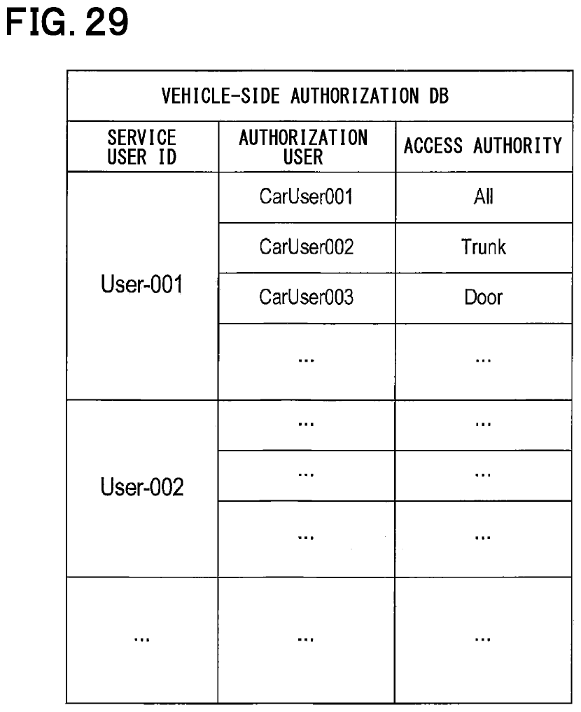

As illustrated in FIG. 29, the vehicle-side authorization DB stores “authorization user” and “access authority” in association with the “service user ID”. In the “authorization user”, IDs (hereinafter, the vehicle user ID) of vehicle users who may actually use the vehicle are listed. That is, a plurality of “authorization users” may be associated with one “service user ID”. The “access authority” is similar to the description in the server-side authorization DB. The “access authority” is set for each “authorization user”.

In the vehicle-side authorization DB, in the target service provided by the service user, for each vehicle user registered as a user of the target service, an access authority of the vehicle user regarding the vehicle access request, that is, information that defines a range that is allowed to be accessed by the vehicle access request is set.

[2-4. Two-Stage Authorization]

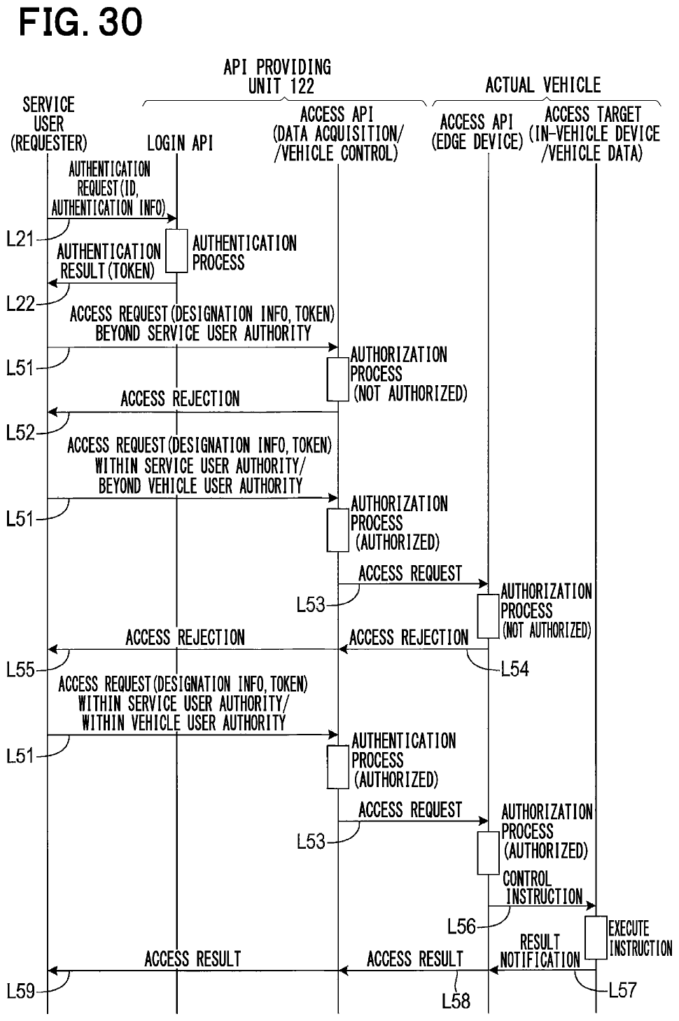

A procedure of two-stage authorization for executing both the authorization process (hereinafter, server-side authorization process) by the management center 3 and the authorization process (that is, vehicle-side authorization process) by the edge device 2 will be described with reference to a sequence diagram of FIG. 30.

Here, a case where the requester makes an access request to the vehicle using the service provided by the service providing server 4 will be described as an example. The requester is, for example, a vehicle user who uses a vehicle. The vehicle user may be an owner of the vehicle or a user who rents the vehicle. The requester is identified by the vehicle user ID. The service provided by the service providing server 4 is identified by the service user ID.

When receiving the vehicle access request from the requester, the service providing server 4 accesses the login API 145 provided by the API providing unit 122 of the management center 3 and executes the authentication process. The procedure of the authentication process is similar to that of the first embodiment as indicated by arrows L21 and L22.

When the authentication process succeeds, the service providing server 4 outputs a vehicle access request (that is, the second data acquisition request or the vehicle control request) corresponding to the request from the requester to the management center 3 using the access API provided by the API providing unit 122 as indicated by an arrow L51. The vehicle access request includes a token given by the authentication process, a vehicle user ID, vehicle designation information, and data designation information or control designation information. The vehicle designation information is information for designating a vehicle (hereinafter, designated vehicle) to be accessed. The data designation information or the control designation information is specific information for identifying an access target. The access target includes vehicle data and various in-vehicle devices.

When the management center 3 receives a vehicle access request from the service providing server 4, the authentication processing unit 144 executes an authorization process.

When the authorization process is executed, the authentication processing unit 144 identifies the “service user ID” from the “token” added to the vehicle access request. Next, the authentication processing unit 144 extracts an “authorization object” and an “access authority” associated with the identified “service user ID” by searching the server-side authorization DB of the authorization information memory unit 142. Further, the authentication processing unit 144 determines whether the designated vehicle indicated in the vehicle access request is included in the extracted “authorization object”, that is, whether access to the designated vehicle is permitted in the service provided by the service user. Further, the authentication processing unit 144 determines whether the extracted “access authority” includes the access target indicated in the vehicle access request, that is, whether access to the access target is permitted in the service provided by the service user.

When the designated vehicle is not included in the “authorization object” or when the access target is not included in the “access authority”, the authentication processing unit 144 determines as unauthorized. In a case where it is determined as unauthorized, the authentication processing unit 144 notifies the requester via the access API and the service providing server 4 of access rejection with beyond authority of the service user as a reason as indicated by an arrow L52.

When the designated vehicle is included in the “authorization object” and the access target is included in the “access authority”, it is determined as authorized, and a vehicle access request is transmitted to the designated vehicle via the vehicle control unit 130 as indicated by an arrow L53.

When receiving the vehicle access request from the management center 3, the vehicle access API 107 of the edge device 2 mounted on the designated vehicle executes the vehicle-side authorization process.

When the vehicle-side authorization process is executed, the second unit 102 refers to the vehicle-side authorization DB and extracts the “authorization user” and the “access authority” associated with the “service user ID” indicated in the vehicle access request. Next, the second unit 102 determines whether the extracted “authorization user” includes the vehicle user ID of the requester indicated in the access request, that is, whether access to the designated vehicle by the requester is permitted. In addition, the second unit 102 determines whether the extracted “access authority” includes the access target indicated in the access request, that is, whether the access to the access target by the requester is permitted.

When the vehicle user ID of the requester is not included in the “authorization user” or the access target is not included in the “access authority”, the second unit 102 determines that the requester is unauthorized. When determining that the request is not authorized, the second unit 102 transmits, to the management center 3 via the vehicle access API 107, an access rejection with beyond the authority of the requester as a reason as indicated by an arrow L54. Upon receiving the access rejection, the management center 3 notifies the requester via the access API and the service providing server 4 of the access rejection as indicated by an arrow L55.

When the vehicle user ID of the requester is included in the “authorization user” and the access target is included in the “access authority”, the second unit 102 determines as authorized. When it is determined as authorized, the second unit 102 transmits a control instruction to the access target as indicated by an arrow L56, and receives an access result from the access target as indicated by an arrow L57. Further, as indicated by an arrow L58, the second unit 102 transmits an access result to the management center 3 via the vehicle access API 107. The management center 3 that has received the access result notifies the requester via the access API and the service providing server 4 of the access result indicated by an arrow L59. The notification of the access result may be encrypted as in the description in the first embodiment.

[2.-5. Vehicle-Side Single Authorization]

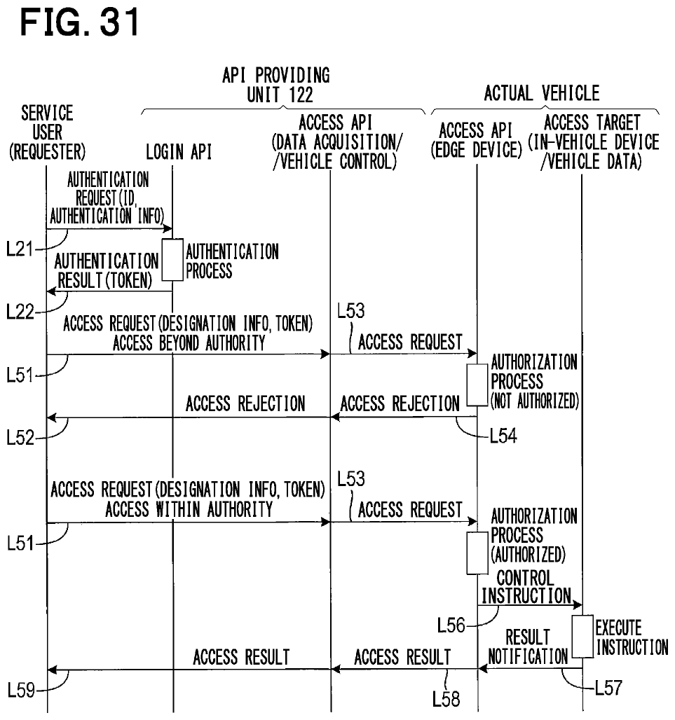

A procedure of the vehicle-side single authorization for executing the authorization process only in the edge device 2 will be described with reference to a sequence diagram of FIG. 31.

Here, as in the case of two-stage authorization, a case where the requester makes an access request to the vehicle using the service provided by the service providing server 4 will be described as an example.

When receiving the vehicle access request from the requester, the service providing server 4 accesses the login API 145 provided by the API providing unit 122 of the management center 3 and executes the authentication process. The procedure of the authentication process is similar to that of the first embodiment as indicated by arrows L21 and L22.

When the authentication process succeeds, the service providing server 4 outputs a vehicle access request corresponding to the request from the requester to the management center 3 using the access API provided by the API providing unit 122 as indicated by an arrow L51.

Upon receiving the access request from the service providing server 4, the management center 3 transmits the vehicle access request to the designated vehicle via the vehicle control unit 130 as indicated by an arrow L53 without executing the center-side authorization process.

When receiving the access request from the management center 3, the vehicle access API 107 of the edge device 2 mounted on the designated vehicle executes the vehicle-side authorization process. The procedure after transmitting the result of the vehicle-side authorization process to the management center 3 is similar to the procedure described in the two-stage authorization as indicated by arrows L54 to L59.

[2.-6. Center-Side Single Authorization]

A procedure of the center-side single authorization in which the authorization process is executed only in the edge device 2 will be described.

In the center-side single authorization, the procedure in the center-side single authorization is similar to the procedure of the two-stage authorization, except that when the vehicle access API 107 of the edge device 2 mounted on the designated vehicle receives the vehicle access request from the management center 3, the vehicle-side authorization process is omitted. That is, in the center-side single authorization, the vehicle-side authorization process is omitted in the sequence illustrated in FIG. 30, and a series of sequences in a case where it is determined as unauthorized in the vehicle-side authorization process is omitted.

[2-7. Correspondence of Terms]

In the embodiment described above, the authorization information memory unit 142 in which the server-side authorization DB is provided corresponds to a server-side memory unit, and the authentication processing unit 144 that executes the server-side authorization process corresponds to a server-side authorization unit. The memory unit 14 or the flash memory 25 provided with the vehicle-side authorization DB corresponds to a vehicle-side memory unit, and the vehicle API 107 that executes the vehicle-side authorization process corresponds to a vehicle-side authorization unit. The content of the server-side authorization DB corresponds to the per-service authorization information, and the content of the vehicle-side authorization DB corresponds to the per-user authorization information.

[2-8. Effects]

According to the second embodiment described in detail above, the effect (1a) of the first embodiment described above is obtained, and the following effect is further obtained.
(2a) In the second embodiment, with respect to the vehicle access request, the management center 3 performs an authorization process (that is, server-side authorization process) in units of service users, and the edge device 2 performs an authorization process (that is, vehicle-side authorization process) in units of vehicle users. Then, in a case where the two-stage authorization for performing both the server-side authorization process and the vehicle-side authorization process is applied, it is possible to suppress access rejection in the vehicle-side authorization process, and eventually, the communication amount between the management center 3 and the edge device 2. When the vehicle-side single authorization is applied, the processing load on the management center 3 can be reduced. When the center-side single authorization is applied, the processing load on the edge device 2 can be reduced.

### 3. Other Embodiments

Although one embodiment of the present disclosure has been described above, the present disclosure is not limited to the above embodiment, and various modifications can be made.
(3a) In the second embodiment, the three procedures of the two-stage authorization, the vehicle-side single authorization, and the center-side single authorization have been described. However, the configuration may be such that any one of the center-side single authorization and the vehicle-side single authorization can be selected by setting the server-side authorization DB. Specifically, any one of “ALL” and “ANY” is set in the “access authority” using the column of the “access authority” in the server-side authorization DB illustrated in FIG. 27. In the case of “ALL”, since it has the access authority to all the access targets, the authorization process is performed only by the management center 3, and in the case of “ANY”, the authorization process in the management center 3 is omitted, and only the authorization process in the edge device 2 is performed. In this case, the service user can flexibly select an authorization method suitable for the service provided by the service user.
(3b) The control unit 31 and the method thereof described in the present embodiment may be realized by a dedicated computer provided by configuring a processor and a memory programmed to execute one or a plurality of functions embodied by a computer program. Alternatively, the control unit 31 and the method thereof described in the present embodiment may be realized by a dedicated computer provided by configuring a processor by one or more dedicated hardware logic circuits. Alternatively, the control unit 31 and the method thereof described in the present embodiment may be realized by one or more dedicated computers configured by a combination of a processor and a memory programmed to execute one or more functions and a processor configured by one or more hardware logic circuits. Furthermore, the computer program may be stored in a computer-readable non-transition tangible recording medium as an instruction executed by a computer. The method for realizing the functions of the units included in the control unit 31 does not necessarily include software, and all the functions may be realized using one or a plurality of pieces of hardware.
(3c) A plurality of functions of one component in the above embodiment may be implemented by a plurality of components, or one function of one component may be implemented by a plurality of components. A plurality of functions of a plurality of components may be implemented by one component, or one function realized by a plurality of components may be implemented by one component. Part of the configuration of the above embodiment may be omitted. At least part of the configuration of the above embodiment may be added to or replaced with the configuration of another above embodiment.
(3d) In addition to the management center 3 described above, the present disclosure can be implemented in various forms such as a system including the management center 3 as a component, a program for causing a computer to function as the management center 3, a non-transitory tangible recording medium such as a semiconductor memory in which the program is recorded, and a vehicle data providing method.

What is claimed is:

1. A mobility service providing system comprising:
an in-vehicle device mounted on a vehicle and configured to collect vehicle data that is data acquired from the vehicle;
a mobility service providing server configured to perform wireless communication with the in-vehicle device,
wherein
the in-vehicle device is configured to repeatedly and spontaneously transmit the vehicle data to the mobility service providing server, and transmits the vehicle data to the mobility service providing server in response to a request from the mobility service providing server, and
the mobility service providing server includes
a memory unit configured to store the vehicle data for each predetermined time point acquired from the in-vehicle device by the wireless communication,
an interface unit configured to accept a first access request and a second access request from an outside,
a first control unit configured to acquire the vehicle data from the memory unit and provide the vehicle data to a request source via the interface unit when the interface unit receives the first access request, and
a second control unit configured to acquire an access result including the vehicle data from the in-vehicle device by accessing the in-vehicle device and provide the access result to a request source via the interface unit when the interface unit receives the second access request.

2. The mobility service providing system according to claim 1, wherein
the second control unit is configured to transmit vehicle authentication information assigned in advance to the in-vehicle device together with an acquisition request to be transmitted to the in-vehicle device in order to acquire the vehicle data from the in-vehicle device, and
the in-vehicle device is configured to transmit the vehicle data requested by the acquisition request to the mobility service providing server when authentication by on the vehicle authentication information is successful.

3. The mobility service providing system according to claim 1, further comprising:
a server-side memory unit configured to store, for each provider of a mobility service using the mobility service providing server, per-service authorization information that defines an accessible range by the second access request; and
a server-side authorization unit configured to, when receiving the second access request, refer to the per-service authorization information to determine whether a provider of the mobility service has an access authority to access a target vehicle that is a vehicle to be accessed indicated in the second access request, and, when it is determined that the provider of the mobility service has the access authority, authorize access to the in-vehicle device mounted on the target vehicle,
wherein
the in-vehicle device further includes
a vehicle-side memory unit configured to store, for each vehicle user who is likely to request access to the target vehicle, per-user authorization information that defines a range accessible by the second access request, and
a vehicle-side authorization unit configured to determine, when receiving the second access request from the mobility service providing server, whether a vehicle user who has requested the second access request has the access authority to an access target indicated in the second access request with reference to the per-user authorization information, and authorize, when it is determined that the vehicle user has the access authority, access to the access target.

4. The mobility service providing system according to claim 1, wherein
the in-vehicle device further includes
a vehicle-side memory unit configured to store, for each vehicle user who is likely to request access to a target vehicle that is a vehicle to be accessed indicated in the second access request, per-user authorization information defining a range that is allowed to be accessed by the second access request, and
a vehicle-side authorization unit configured to determine, when receiving the second access request from the mobility service providing server, whether a vehicle user who has requested the second access request has an access authority to an access target indicated in the second access request with reference to the per-user authorization information, and authorize, when it is determined that the vehicle user has the access authority, access to the access target.

5. The mobility service providing system according to claim 1, wherein
the vehicle data transmitted by the in-vehicle device includes processed data obtained by processing raw data acquired from the vehicle, and the vehicle data transmitted by the in-vehicle device in response to a request from the mobility service providing server includes the raw data before being processed.

6. A mobility service providing server comprising:
a memory unit configured to store vehicle data provided from an in-vehicle device mounted on a vehicle;
an interface unit configured to receive a first access request and a second access request from an outside;
a first control unit configured to acquire the vehicle data from the memory unit and provide the vehicle data to a request source via the interface unit when the interface unit receives the first access request; and
a second control unit configured to acquire an access result including the vehicle data from the in-vehicle device by accessing the in-vehicle device and provide the access result to a request source via the interface unit when the interface unit receives the second access request.

7. The mobility service providing server according to claim 6, wherein
the first access request and the second access request include user identification information for identifying a service user who provides a service using the mobility service providing server, and
the interface unit further includes
an authorization information memory unit configure to store the user identification information in association with an authorization class representing a range of the acquirable vehicle data, and
an authorization unit configured to reject acceptance of an acquisition request when the vehicle data to be acquired indicated in the first access request and the second access request is out of a range of an authority authorized by the authorization class according to the authorization class acquired from the authorization information memory unit based on the user identification information indicated in the first access request and the second access request.

8. The mobility service providing server according to claim 6, wherein
the memory unit includes
a first database configured to set, as a shadow, a group of pieces of the vehicle data spontaneously transmitted from the in-vehicle device and indicating a state of the vehicle on which the in-vehicle device is mounted at a same time, and store, as a shadow version, information indicating a time when the shadow has been generated, and
a second database configured to store an index generated corresponding to the shadow accumulated in the first database,
the index includes, with the vehicle that is a provider of the vehicle data belonging to the shadow as a provider vehicle, vehicle identification information that identifies the provider vehicle extracted from the shadow, position information about the provider vehicle, and the shadow version,
the first control unit is configured to extract the index corresponding to acquisition condition indicated in the first access request from the second database, and acquire the shadow identified from the extracted index from the first database.

9. The mobility service providing server according to claim 8, wherein
the first control unit is configured to, when the acquisition condition includes time designation information designating a time or a time range, extract the index whose shadow version corresponds to the time designation information from the second database.

10. The mobility service providing server according to claim 8, wherein
the first control unit is configured to, when the acquisition condition includes area designation information designating a geographical area, extract, from the second database, the index indicating an area in which the position information is designated by the area designation information.

11. The mobility service providing server according to claim 6, wherein
the second control unit includes
an encryption information generation unit configured to generate encryption information to transmit a key used to decrypt an encrypted text generated using the encryption information to a notification destination designated by the second access request when the interface unit receives the second access request, and
an encryption unit configured to encrypt the vehicle data acquired by requesting the in-vehicle device in accordance with the second access request using the encryption information generated by the encryption information generation unit and provide the encrypted vehicle data to a request source via the interface unit.

12. A vehicle data providing method in a mobility service providing server including a memory unit configured to store vehicle data provided from an in-vehicle device mounted on a vehicle, and an interface unit configured to receive a first access request and a second access request from an outside, the vehicle data providing method comprising:
acquiring the vehicle data from the memory unit and providing the vehicle data to a request source via the interface unit when the interface unit receives the first access request; and
acquiring an access result including the vehicle data from the in-vehicle device by accessing the in-vehicle device and providing the access result to a request source via the interface unit when the interface unit receives the second access request.

13. A vehicle data providing method in a mobility service providing system including an in-vehicle device mounted on a vehicle and configured to collect vehicle data that is data acquired from the vehicle, a mobility service providing server configured to perform wireless communication with the in-vehicle device, the vehicle data providing method comprising:
with the in-vehicle device, repeatedly and spontaneously transmitting the vehicle data to the mobility service providing server, and transmitting the vehicle data to the mobility service providing server in response to a request from the mobility service providing server, and
with the mobility service providing server,
storing to a memory unit, the vehicle data for each predetermined time point acquired from the in-vehicle device by the wireless communication,
acquiring the vehicle data from the memory unit and providing the vehicle data to a request source via the interface unit when the interface unit receives the first access request, the interface unit being configured to accept a first access request and a second access request from an outside, and
acquiring an access result including the vehicle data from the in-vehicle device by accessing the in-vehicle device and providing the access result to a request source via the interface unit when the interface unit receives the second access request.

14. A non-transitory computer-readable storage medium storing a program for causing a computer to function as a first control unit and a second control unit, the computer including a mobility service providing server together with a memory unit configured to store vehicle data provided from an in-vehicle device mounted on a vehicle, and an interface unit configured to receive a first access request and a second access request from an outside,
the first control unit acquiring the vehicle data from the memory unit and providing the vehicle data to a request source via the interface unit when the interface unit receives the first access request, and
the second control unit acquiring an access result including the vehicle data from the in-vehicle device by accessing the in-vehicle device and providing the access result to a request source via the interface unit when the interface unit receives the second access request.
